(19) United States
(12) Patent Application Publication
(10) Pub. No.: US 2025/0274716 A1
(43) Pub. Date: Aug. 28, 2025

(54) VIBRATION GENERATING MODULE, SOUND APPARATUS COMPRISING THE SAME, AND VEHICULAR APPARATUS

(71) Applicant: LG Display Co., Ltd., Seoul (KR)

(72) Inventors: SiHyun KIM, Paju-si (KR); Chiwan KIM, Paju-si (KR); Yong-Su HAM, Paju-si (KR)

(73) Assignee: LG Display Co., Ltd., Seoul (KR)

(21) Appl. No.: 19/060,514

(22) Filed: Feb. 21, 2025

(30) Foreign Application Priority Data
Feb. 26, 2024 (KR) 10-2024-0027488

(51) Int. Cl. H04R 17/00; H04R 1/02

(52) U.S. Cl. CPC H04R 17/00; H04R 1/025; H04R 2499/13

(57) ABSTRACT

A vibration generating module, a sound apparatus comprising the same, and a vehicular apparatus are provided. The vibration generating module comprises a vibration member; a pad portion on a first surface of the vibration member; a first vibration apparatus on the first surface of the vibration member and connected to the pad portion; and a second vibration apparatus on a second surface opposite to the first surface of the vibration member and connected to the pad portion. Accordingly, the vibration generating module, the sound apparatus comprising the same and the vehicular apparatus may have improved sound characteristics and/or improved sound pressure characteristics.

### CROSS-REFERENCE TO RELATED APPLICATIONS

This application claims the benefit of the Korean Patent Application No. 10-2024-0027488 filed on Feb. 26, 2024, which is hereby incorporated by reference as if fully set forth herein.

### BACKGROUND

### Technical Field

The present disclosure relates to a vibration generating module, a sound apparatus comprising the same, and a vehicular apparatus.

### Description of the Related Art

A vehicle may include a sound apparatus that outputs sound in accordance with an audio signal output from a multimedia device such as a car audio player. For example, the sound apparatus applied to the vehicle may include a front speaker and a rear speaker, which are configured in a coil type.

### BRIEF SUMMARY

The sound apparatus in the vehicle has a limitation in outputting realistic sound or stereoscopic sound of a multi-channel through the front and rear speakers. The sound apparatus in the vehicle may output stereoscopic sound when the number of speakers is increased, but there is a limitation in increasing the number of speakers due to a size of speakers according to the coil type and spatial constraints in the vehicle.

The inventors of the present disclosure have recognized the above-mentioned problems and conducted various studies and experiments capable of improving sound characteristics and/or sound pressure characteristics of a vehicle sound apparatus. The inventors of the present disclosure have provided various embodiments of a vibration generating module capable of improving sound characteristics and/or sound pressure characteristics, a sound apparatus comprising the same, and a vehicular apparatus through various studies and experiments.

The present disclosure has been made in view of the various problems in the related art, including the above identified problems. Various embodiments of the present disclosure provide a vibration generating module capable of improving sound characteristics and/or sound pressure characteristics, a sound apparatus comprising the same, and a vehicular apparatus.

Various embodiments of the present disclosure provide a vibration generating module capable of reducing volume and thickness, a sound apparatus comprising the same, and a vehicular apparatus.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other advantages and embodiment of the present disclosure, as embodied and broadly described herein, in one or more embodiments, a vibration generating module may comprise a vibration member, a pad portion on a first surface of the vibration member, a first vibration apparatus on the first surface of the vibration member and connected to the pad portion, and a second vibration apparatus on a second surface opposite to the first surface of the vibration member and connected to the pad portion.

To achieve these and other advantages and embodiment of the present disclosure, as embodied and broadly described herein, in one or more embodiments, a sound apparatus may comprise an enclosure having an inner space, and a vibration generating module in the inner space, wherein the vibration generating module may be the vibration generating module described above. The vibration generating module may comprise a vibration member, a pad portion on a first surface of the vibration member, a first vibration apparatus on the first surface of the vibration member and connected to the pad portion, and a second vibration apparatus on a second surface opposite to the first surface of the vibration member and connected to the pad portion.

To achieve these and other advantages and embodiment of the present disclosure, as embodied and broadly described herein, in one or more embodiments, a vehicular apparatus may comprise an interior material exposed to an indoor space, and at least one sound generating apparatus outputting sound to the indoor space, wherein the at least one sound generating apparatus may include the sound apparatus described above. The sound apparatus may comprise an enclosure having an inner space, and a sound generating module in the inner space, wherein the sound generating module may include the vibration generating module described above. The vibration generating module may comprise a vibration member, a pad portion on a first surface of the vibration member, a first vibration apparatus on the first surface of the vibration member and connected to the pad portion, and a second vibration apparatus on a second surface opposite to the first surface of the vibration member and connected to the pad portion.

Details of other exemplary embodiments besides the above embodiments will be included in the detailed description of the disclosure and the accompanying drawings.

According to one or more embodiments of the present disclosure, the vibration generating module, the sound apparatus comprising the same and the vehicular apparatus may have improved sound characteristics and/or improved sound pressure characteristics.

According to one or more embodiments of the present disclosure, since the vibration generating module, the sound apparatus comprising the same and the vehicular apparatus simplify the structure of the vibration generating module, a lightweight effect may be obtained by reducing volume and thickness.

According to one or more embodiments of the present disclosure, the vibration generating module, the sound apparatus comprising the same and the vehicular apparatus may constitute the signal supply member and the vibration apparatus as a single component, thereby obtaining the effect of uni-materialization.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following detailed description are exemplary and explanatory and are intended to provide further explanation of the inventive concepts as claimed.

### BRIEF DESCRIPTION OF THE SEVERAL VIEWS OF THE DRAWINGS

The above and other objects, features and other advantages of the present disclosure will be more clearly understood from the following detailed description taken in conjunction with the accompanying drawings, in which:

FIG. 1 is a perspective view illustrating a vibration generating module according to the embodiment of the present disclosure;

FIG. 2 is an exploded perspective view illustrating a vibration generating module according to the embodiment of the present disclosure;

FIG. 3 is a cross-sectional view taken along line I-I′ shown in FIG. 1 according to the embodiment of the present disclosure;

FIG. 4 is a cross-sectional view taken along line II-II′ shown in FIG. 1 according to the embodiment of the present disclosure;

FIG. 5 is a view illustrating a sound apparatus according to the embodiment of the present disclosure;

FIG. 6 is a view illustrating a sound apparatus according to another embodiment of the present disclosure;

FIG. 7 is a cross-sectional view illustrating a sound apparatus according to the embodiment of the present disclosure;

FIG. 8 is a view illustrating a vibration portion according to another embodiment of the present disclosure;

FIG. 9 is a view illustrating a vibration portion according to another embodiment of the present disclosure;

FIG. 10 is a view illustrating a vehicular apparatus according to the embodiment of the present disclosure;

FIG. 11 is a view illustrating a vehicular apparatus according to the embodiment of the present disclosure;

FIG. 12 is a view illustrating a sound generating apparatus disposed on a roof of a vehicular apparatus of FIGS. 10 and 11;

FIG. 13 is a view illustrating a sound generating apparatus disposed on a roof and a seat of the vehicular apparatus of FIGS. 10 and 11; and

FIG. 14 is a view illustrating sound output characteristics of a sound apparatus according to embodiments and experimental examples of the present disclosure.

### DETAILED DESCRIPTION

Reference is now made in detail to aspects of the present disclosure, examples of which may be illustrated in the accompanying drawings. In the following description, when a detailed description of well-known functions, structures or configurations can unnecessarily obscure aspects of the present disclosure, a detailed description of such known functions or configurations can have been omitted for brevity. Further, repetitive descriptions can be omitted for brevity. The progression of processing steps and/or operations described is a non-limiting example.

The sequence of steps and/or operations is not limited to that set forth herein and can be changed to occur in an order that is different from an order described herein, with the exception of steps and/or operations necessarily occurring in a particular order. In one or more examples, two operations in succession can be performed substantially concurrently, or the two operations can be performed in a reverse order or in a different order depending on a function or operation involved.

Unless stated otherwise, like reference numerals can refer to like elements throughout even when they are shown in different drawings. In one or more aspects, identical elements (or elements with identical names) in different drawings can have the same or substantially the same functions and properties unless stated otherwise. Names of the respective elements used in the following explanations are selected only for convenience and can be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure can be thorough and complete to assist those skilled in the art to understand the inventive concepts without limiting the protected scope of the present disclosure.

Shapes (e.g., sizes, lengths, widths, heights, thicknesses, locations, radii, diameters, and areas), dimensions, ratios, angles, numbers, and the like disclosed herein, including those illustrated in the drawings, are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

Where a term like “comprise,” “have,” “include,” “contain,” or the like is used with respect to one or more elements, one or more other elements can be added unless a term such as “only” or the like is used. The terms used in the present disclosure are merely used in order to describe example aspects, and are not intended to limit the scope of the present disclosure. The terms of a singular form can include plural forms unless the context clearly indicates otherwise.

The word “exemplary” is used to mean serving as an example or illustration, unless otherwise specified. Aspects are example aspects. “Embodiments,” “examples,” “aspects,” and the like should not be construed as preferred or advantageous over other implementations. An embodiment, an example, an example aspect, an aspect, or the like can refer to one or more embodiments, one or more examples, one or more example aspects, one or more aspects, or the like, unless stated otherwise. Further, the term “may” encompasses all the meanings of the term “can.”

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range can be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more other parts can be located between the two parts unless a more limiting term, such as “immediate(ly),” “direct(ly),” or “close(ly),” is used. For example, where a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as, for example, “after,” “subsequent,” “next,” “before,” “preceding,” “prior to,” or the like, a case that is not consecutive or not sequential can be included and thus one or more other events can occur therebetween, unless a more limiting term, such as “just,” “immediate(ly),” or “direct(ly),” is used.

The terms, such as “below,” “lower,” “above,” “upper” and the like, can be used herein to describe a relationship between element(s) as illustrated in the drawings. It will be understood that the terms are spatially relative and based on the orientation depicted in the drawings.

It is understood that, although the terms “first,” “second,” or the like can be used herein to describe various elements (e.g., layers, films, regions, components, sections, or the like), these elements should not be limited by these terms, for example, to any particular order, precedence, or number of elements. These terms are used only to distinguish one element from another. For example, a first element could be termed a second element, and, similarly, a second element could be termed a first element, without departing from the scope of the present disclosure. Furthermore, the first element, the second element, and the like can be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element can include one or more first elements. Similarly, a second element or the like can include one or more second elements or the like.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “contacts,” “overlaps,” or the like with another element, the element can not only directly contact, overlap, or the like with another element, but also indirectly contact, overlap, or the like with another element with one or more intervening elements disposed or interposed between the elements, unless otherwise specified.

The phrase that an element (e.g., layer, film, region, component, section, or the like) is “provided in,” “disposed in,” or the like in another element can be understood as that at least a portion of the element is provided in, disposed in, or the like in another element, or that the entirety of the element is provided in, disposed in, or the like in another element. The phrase that an element (e.g., layer, film, region, component, section, or the like) “contacts,” “overlaps,” or the like with another element can be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The phrase “A filled in B” does not imply that A is exclusively contained within B to the exclusion of other materials. Instead, it is intended to encompass a broad range of conditions, including but not limited to “partially filled in,” “substantially filled in,” “completely filled in,” and “exclusively filled in.” Similarly, the phrase “B filled with A” does not suggest that B is exclusively filled with A, excluding other materials. Rather, it covers various degrees of filling, such as “partially filled with,” “substantially filled with,” “completely filled with,” and “exclusively filled with.”

The terms such as a “line” or “direction” should not be interpreted only based on a geometrical relationship in which the respective lines or directions are parallel or perpendicular to each other. Such terms can mean a wider range of lines or directions within which the components of the present disclosure can operate functionally. For example, the terms “first direction,” “second direction,” and the like, such as a direction parallel or perpendicular to “X-axis,” “Y-axis,” or “Z-axis,” should not be interpreted only based on a geometrical relationship in which the respective directions are parallel or perpendicular to each other, and can be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item,” can represent (i) a combination of items provided by two or more of the first item, the second item, and the third item or (ii) only one of the first item, the second item, or the third item.

The expression of a first element, a second elements, “and/or” a third element should be understood to encompass one of the first, second, and third elements, as well as any and all combinations of the first, second and third elements. By way of example, A, B and/or C encompass only A; only B; only C; any of A, B, and C (e.g., A, B, or C); some combinations of A, B, and C (e.g., A and B; A and C; or B and C); and all of A, B, and C. Furthermore, an expression “A/B” can be understood as A and/or B. For example, an expression “A/B” can refer to only A; only B; A or B; or A and B.

In one or more aspects, the terms “between” and “among” can be used interchangeably simply for convenience unless stated otherwise. For example, an expression “between a plurality of elements” can be understood as among a plurality of elements. In another example, an expression “among a plurality of elements” can be understood as between a plurality of elements. In one or more examples, the number of elements can be two. In one or more examples, the number of elements can be more than two. Furthermore, when an element (e.g., layer, film, region, component, sections, or the like) is referred to as being “between” at least two elements, the element can be the only element between the at least two elements, or one or more intervening elements can also be present.

In one or more aspects, the phrases “each other” and “one another” can be used interchangeably simply for convenience unless stated otherwise. For example, an expression “different from each other” can be understood as different from one another. In another example, an expression “different from one another” can be understood as different from each other. In one or more examples, the number of elements involved in the foregoing expression can be two. In one or more examples, the number of elements involved in the foregoing expression can be more than two.

In one or more aspects, the phrases “one or more among” and “one or more of” can be used interchangeably simply for convenience unless stated otherwise.

The term “or” means “inclusive or” rather than “exclusive or.” For example, unless otherwise stated or clear from the context, the expression that “x uses a or b” means any one of natural inclusive permutations. For example, “a or b” can mean “a,” “b,” or “a and b.” For example, “a, b or c” can mean “a,” “b,” “c,” “a and b,” “b and c,” “a and c,” or “a, b and c.”

Features of various aspects of the present disclosure can be partially or entirely coupled to or combined with each other, can be technically associated with each other, and can be operated, linked, or driven together in various ways. Aspects of the present disclosure can be implemented or carried out independently from each other, or can be implemented or carried out together in a co-dependent or related relationship. In one or more aspects, the components of each apparatus according to various aspects of the present disclosure can be operatively coupled and configured.

Unless otherwise defined, the terms (including technical and scientific terms) used herein have the same meaning as commonly understood by one of ordinary skill in the art to which example aspects belong. It should be further understood that terms, such as those defined in commonly used dictionaries, should be interpreted as having a meaning, for example, consistent with their meaning in the context of the relevant art and should not be interpreted in an idealized or overly formal sense, unless expressly defined otherwise herein.

The terms used herein have been selected as being general in the related technical field; however, there can be other terms depending on the development and/or change of technology, convention, preference of technicians, and so on. Therefore, the terms used herein should not be understood as limiting technical ideas, but should be understood as examples of the terms for describing example aspects.

Further, in a specific case, a term can be arbitrarily selected by an applicant, and in this case, the detailed meaning thereof is described herein. Therefore, the terms used herein should be understood based on not only the name of the terms, but also the meaning of the terms and the content hereof.

“X-axis direction,” “Y-axis direction” and “Z-axis direction” should not be construed by a geometric relation only of a mutual vertical relation and can have broader directionality within the range that elements of the present disclosure can act functionally.

In the following description, various example aspects of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements can be denoted by the same reference numerals even though they are depicted in different drawings.

In addition, for convenience of description, a scale, dimension, size, and thickness of each of the elements illustrated in the accompanying drawings can be different from an actual scale, dimension, size, and thickness, and thus, aspects of the present disclosure are not limited to a scale, dimension, size, and thickness illustrated in the drawings.

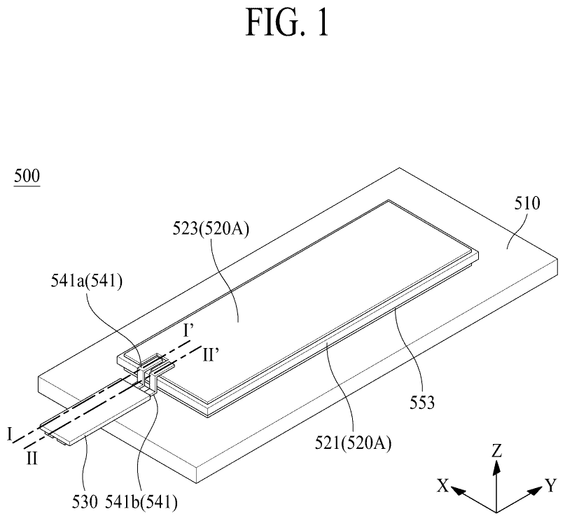

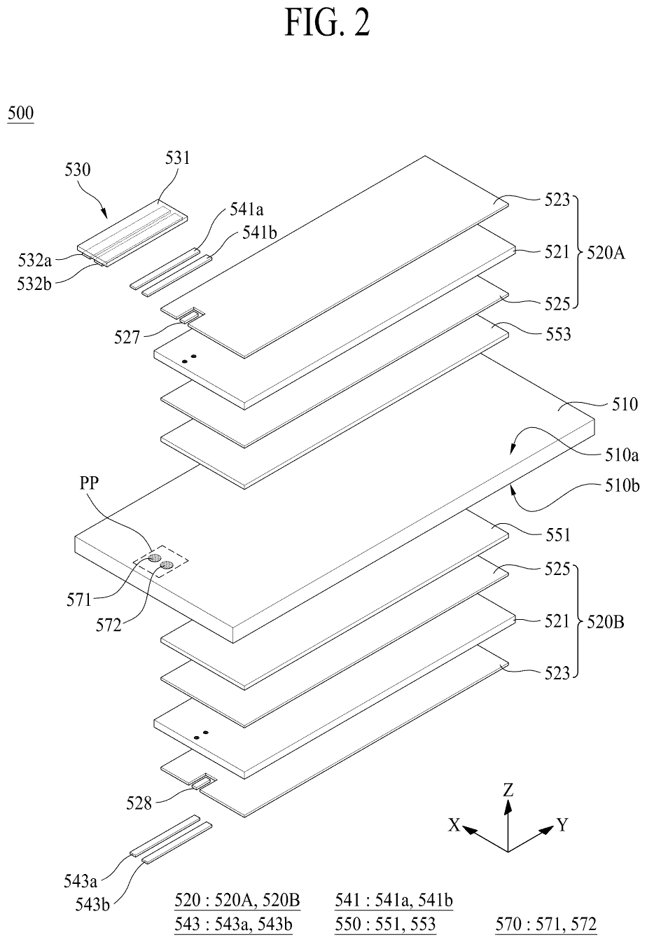

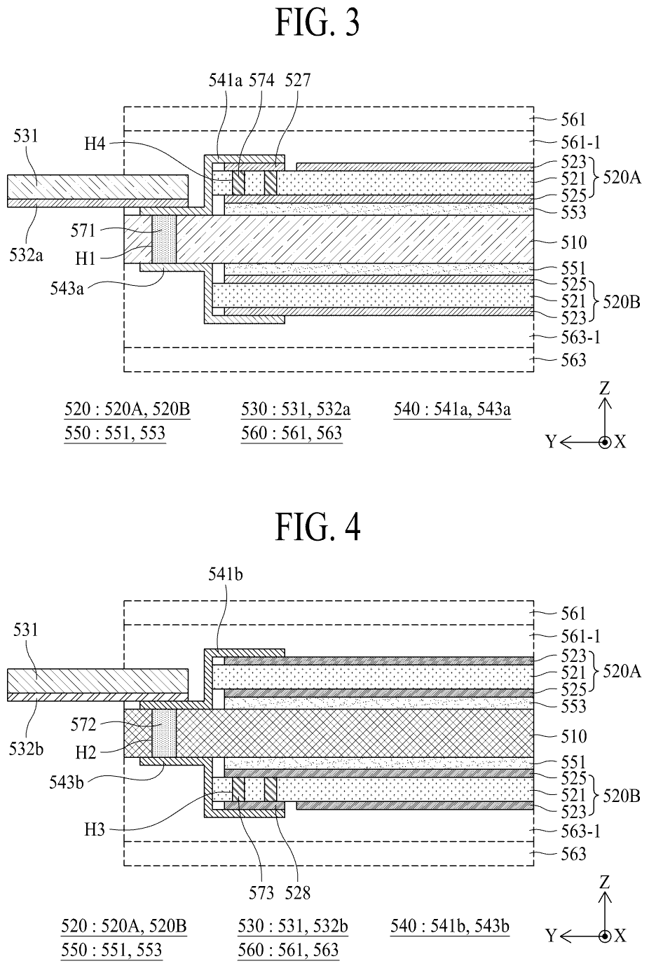

FIG. 1 is a perspective view illustrating a vibration generating module according to the embodiment of the present disclosure. FIG. 2 is an exploded perspective view illustrating a vibration generating module according to the embodiment of the present disclosure. FIG. 3 is a cross-sectional view taken along line I-I′ shown in FIG. 1 according to the embodiment of the present disclosure. FIG. 4 is a cross-sectional view taken along line II-II′ shown in FIG. 1 according to the embodiment of the present disclosure.

Referring to FIGS. 1 to 4, a vibration generating structure 500 (hereinafter also referred to as “a vibration generating module 500”) according to the embodiment of the present disclosure may include a vibration member 510 and a vibration apparatus 520.

The vibration member 510 may generate vibration or output sound (or sound waves or sound pressure) according to the driving (or vibration) of the vibration apparatus 520. For example, the vibration member 510 may be a diaphragm, a vibration plate, a vibration object, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 510 may include a single nonmetal material or a composite nonmetal material, but embodiments of the present disclosure are not limited thereto. For example, the single nonmetal material or the composite nonmetal material of the vibration member 510 may include one or more of wood, rubber, plastic, carbon, glass, fiber, cloth, paper, mirror, and leather, but embodiments of the present disclosure are not limited thereto. For example, the paper may be cone paper for speakers. For example, the cone paper may be pulp or foamed plastic, or the like, but embodiments of the present disclosure are not limited thereto.

The vibration member 510 according to one embodiment of the present disclosure may be composed of a plastic material or styrene material, but the embodiments of the present disclosure are not limited thereto.

The plastic material of the vibration member 510 may be composed of polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), but the embodiments of the present disclosure are not limited thereto.

The styrene material of the vibration member 510 may be an ABS material. The ABS material may be acrylonitrile, butadiene, and styrene.

A vibration member 510 according to an aspect of the present disclosure may be formed of a porous material. For example, the vibration member 510 may include a micro cellular plastics material. For example, the vibration member 510 may be formed of a micro cellular polyethylene terephthalate material (MCPET). The vibration member 510 composed of MCPET has low density and excellent elasticity, whereby it has high sound reproduction capability, thereby improving sound quality. The vibration member 510 according to the embodiment of the present disclosure may be made of stainless steel.

According to the embodiment of the present disclosure, the vibration member 510 may include a rectangular shape, but the embodiments of the present disclosure are not limited thereto. For example, the vibration member 510 may have a rectangular shape having a long side and a short side, but the embodiments of the present disclosure are not limited thereto. For example, the vibration member 510 may include a first surface 510a and a second surface 510b different from (or opposite to) the first surface 510a. For example, in the vibration member 510, the first surface 510a may be a front surface or an upper surface, and the second surface 510b may be a rear surface, a back surface, or a lower surface. For example, the first surface 510a of the vibration member 510 may correspond to a first surface of the vibration generating module 500. For example, the second surface 510b of the vibration member 510 may correspond to a second surface of the vibration generating module 500.

According to the embodiment of the present disclosure, the vibration member 510 may have an area larger than an area of the vibration apparatus 520, but the embodiments of the present disclosure are not limited thereto. The vibration apparatus 520 may be configured on the first surface 510a and the second surface 510b of the vibration member 510.

Referring to FIGS. 1 and 2, the vibration generating module 500 according to the embodiment of the present disclosure may include a pad portion PP. For example, the pad portion PP may be formed on the first surface (or upper surface) of the vibration member. For example, a first vibration apparatus 520A and a second vibration apparatus 520B may be connected to the pad portion PP. For example, the pad portion PP may be electrically connected to a signal supply member 530. For example, the pad portion PP may include a connection portion 570 electrically connected to a first connection member 541 and a second connection member 543, which will be described below.

Referring to FIGS. 2 to 4, according to the embodiment of the present disclosure, the connection portion 570 may be configured to pass through the first surface (or upper surface) and the second surface (or lower surface) of the vibration member 510. For example, the connection portion 570 may include a first connection portion 571 and a second connection portion 572. The first connection portion 571 and the second connection portion 572 may be configured to pass through the first surface (or upper surface) and the second surface (or lower surface) of the vibration member 510. The first connection portion 571 and the second connection portion 572 may be configured to be parallel with each other. The first connection portion 571 may be electrically connected to any one of the first connection member 541 and the second connection member 543, and the second connection portion 572 may be electrically connected to the other one of the first connection member 541 and the second connection member 543. For example, the first connection portion 571 may electrically connect a first conductive member 541a of the first connection member 541 with a first conductive member 543a of the second connection member 543. For example, the second connection portion 572 may electrically connect a second conductive member 541b of the first connection member 541 with a second conductive member 543b of the second connection member 543.

According to the embodiment of the present disclosure, the first connection portion 571 may include a first hole H1 passing through the first surface (or upper surface) and the second surface (or lower surface) of the vibration member 510, and a conductive material filled in the first hole H1. The second connection portion 572 may include a second hole H2 passing through the first surface (or upper surface) and the second surface (or lower surface) of the vibration member 510, and a conductive material filled in the second hole H2. For example, each of the first hole H1 and the second hole H2 may be configured to pass through the vibration member 510 and to be adjacent to the signal supply member 530. For example, the first hole H1 and the second hole H2 may be configured to pass through one side of the vibration member 510. For example, the first hole H1 and the second hole H2 may be spaced apart from each other and configured to be parallel with each other. For example, the conductive material may include lead (Pb) or silver (Ag), but is not limited thereto.

Referring to FIGS. 1 to 4, the vibration apparatus 520 may be configured to vibrate the vibration member 510. The vibration apparatus 520 may be configured to vibrate (or displace) the vibration member 510. For example, the vibration apparatus 520 may be configured to be vibrated (or displaced or driven) in accordance with a driving signal (or a vibration driving signal or a voice signal) applied thereto, thereby vibrating (or displacing or driving) the vibration member 510.

The vibration apparatus 520 may have a shape corresponding to or the same as the vibration member 510, but the embodiments of the present disclosure are not limited thereto. For example, the vibration apparatus 520 may have a shape different from that of the vibration member 510. For example, the vibration apparatus 520 may include a rectangular shape or a square shape, but the embodiments of the present disclosure are not limited thereto. For example, the vibration apparatus 520 may include a size smaller than that of the vibration member 510, but the embodiments of the present disclosure are not limited thereto.

The vibration apparatus 520 may be disposed or configured on the vibration member 510. For example, the vibration apparatus 520 may be disposed or configured on one or more of the first surface and the second surface of the vibration member 510. For example, the vibration generating module 500 may include a plurality of vibration apparatuses 520A and 520B. For example, the plurality of vibration apparatuses 520A and 520B may be disposed or configured on one or more of the first surface and the second surface of the vibration member 510 with the vibration member 510 interposed therebetween.

The vibration apparatus 520 according to the embodiment of the present disclosure may include a first vibration apparatus 520A and a second vibration apparatus 520B.

The first vibration apparatus 520A and the second vibration apparatus 520B may be configured on the vibration member 510. For example, the first vibration apparatus 520A and the second vibration apparatus 520B may be disposed with the vibration member 510 interposed therebetween. For example, the first vibration apparatus 520A may be disposed or configured on the first surface (or upper surface) of the vibration member 510. For example, the second vibration apparatus 520B may be disposed or configured on the second surface (or lower surface) of the vibration member 510, which is different from the first surface of the vibration member 510.

According to the embodiment of the present disclosure, long sides of the first vibration apparatus 520A and the second vibration apparatus 520B are parallel with a long side of the vibration member 510, and may be spaced apart from the long side of the vibration member 510. Each of the first vibration apparatus 520A and the second vibration apparatus 520B may have a smaller size than the vibration member 510.

Each of the first vibration apparatus 520A and the second vibration apparatus 520B may be configured to be vibrated (or displaced or driven) in accordance with a driving signal (or a vibration driving signal or a voice signal) applied thereto, thereby vibrating (or displacing or driving) the vibration member 510. The vibration member 510 may generate vibration or output sound (or sound wave) in accordance with displacement (or driving) of each of the first vibration apparatus 520A and the second vibration apparatus 520B.

According to the embodiment of the present disclosure, the driving signals (or the vibration driving signals or the voice signals) applied to the first vibration apparatus 520A and the second vibration apparatus 520B may be the same as or different from each other. For example, the driving signals applied to the first vibration apparatus 520A and the second vibration apparatus 520B may have the same phase or different phases. For example, the first vibration apparatus 520A and the second vibration apparatus 520B may have a bimorph structure in which they are disposed with the vibration member 510 interposed therebetween. Since the first vibration apparatus 520A and the second vibration apparatus 520B may vibrate the vibration member 510 independently, an influence on sound characteristics according to material and characteristics of the vibration member 510 may be reduced. Accordingly, sound characteristics and/or sound pressure characteristics of the sound apparatus 30 may be improved.

According to another embodiment of the present disclosure, the first vibration apparatus 520A and the second vibration apparatus 520B may be configured on any one of the first surface and the second surface of the vibration member 510. For example, the first vibration apparatus 520A may be configured on any one of the first surface and the second surface of the vibration member 510. For example, the first vibration apparatus 520A may be connected to or configured on the first surface 510a of the vibration member 510. For example, the second vibration apparatus 520B may be connected to or configured on the second surface 510b of the vibration member 510. For example, the second vibration apparatus 520B may be connected to the first vibration apparatus 520A. For example, the first vibration apparatus 520A and the second vibration apparatus 520B may be disposed or stacked with the vibration member 510 interposed therebetween.

According to the embodiment of the present disclosure, each of the first vibration apparatus 520A and the second vibration apparatus 520B of the vibration apparatus 520 may include a piezoelectric material having piezoelectric characteristics.

Each of the first vibration apparatus 520A and the second vibration apparatus 520B may vibrate (or displace or drive) a vibration member (or a vehicle interior material) based on a vibration (or displacement or driving) of the piezoelectric material based on an electric signal (or a voice signal or a sound signal) applied to the piezoelectric material. For example, each of the first vibration apparatus 520A and the second vibration apparatus 520B may alternately repeat contraction and/or expansion by a piezoelectric effect (or a piezoelectric characteristic) to vibrate (or displace or drive). For example, each of the first vibration apparatus 520A and the second vibration apparatus 520B may vibrate (or displace or drive) in a vertical direction (or a thickness direction) Z as contraction and/or expansion are alternately repeated by an inverse piezoelectric effect. For example, the piezoelectric material of each of the first vibration apparatus 520A and the second vibration apparatus 520B, which contains piezo ceramic, may be vibrated or mechanically displaced (or vibrated or driven) in response to an electric signal applied from the outside.

Each of the first vibration apparatus 520A and the second vibration apparatus 520B may be configured as a ceramic-based piezoelectric material capable of implementing a relatively strong vibration, or may be configured as a piezoelectric ceramic having a perovskite-based crystal structure. For example, the first vibration apparatus 520A and the second vibration apparatus 520B may be a vibration generating device, a vibration film, a vibration generating film, a vibrator, an active vibrator, an active vibration generator, an actuator, an exciter, a film actuator, a film exciter, an ultrasonic actuator, or an active vibration member, or the like, but embodiments of the present disclosure are not limited thereto.

Each of the first vibration apparatus 520A and the second vibration apparatus 520B may include a vibration portion 521, a first electrode portion 523, and a second electrode portion 525.

The vibration portion 521 may include a piezoelectric material or an electroactive material which includes a piezoelectric effect, but embodiments of the present disclosure are not limited thereto. For example, the vibration portion 521 may be a piezoelectric layer, a piezoelectric material layer, an electroactive layer, a piezoelectric composite layer, a piezoelectric composite, or a piezoelectric ceramic composite, or the like, but embodiments of the present disclosure are not limited thereto.

The vibration portion 521 may be configured as a ceramic-based material capable of implementing a relatively strong vibration, or may be configured as a piezoelectric ceramic having a perovskite-based crystalline structure. For example, the vibration portion 521 may include at least one or more of lead titanate (PbTiO₃), lead zirconate (PbZrO₃), lead zirconate titanate (PbZrTiO₃), barium titanate (BaTiO₃), and strontium titanate (SrTiO₃), but embodiments of the present disclosure are not limited thereto.

The piezoelectric ceramic may be configured as a single crystalline ceramic having a crystalline structure, or may be configured as a ceramic material having a polycrystalline structure or polycrystalline ceramic. A piezoelectric material including the single crystalline ceramic may include α-AlPO₄, α-SiO₂, LiNbO₃, Tb₂(MoO₄)₃, Li₂B₄O₇, or ZnO, but embodiments of the present disclosure are not limited thereto. A piezoelectric material including the polycrystalline ceramic may include a lead zirconate titanate (PZT)-based material, including lead (Pb), zirconium (Zr), and titanium (Ti), or may include a lead zirconate nickel niobate (PZNN)-based material, including lead (Pb), zirconium (Zr), nickel (Ni), and niobium (Nb), but embodiments of the present disclosure are not limited thereto. For example, the vibration portion 521 may include at least one or more of CaTiO₃, BaTiO₃, and SrTiO₃, without lead (Pb), but embodiments of the present disclosure are not limited thereto.

Referring to FIG. 3, the vibration portion 521 of the first vibration apparatus 520A may include a fourth hole H4 configured to be adjacent to the signal supply member 530. The fourth hole H4 may be configured to pass through one side of the vibration portion 521. For example, a fourth connection portion 574 may be filled in the fourth hole H4 in the vibration portion 521 of the first vibration apparatus 520A. The fourth connection portion 574 may be filled in the fourth hole H4, and thus may electrically connect the first connection member 541 with the second electrode portion 525 of the first vibration apparatus 520A. For example, the fourth connection portion 574 may be filled in the fourth hole H4 to electrically connect the first conductive member 541a with the second electrode portion 525 of the first vibration apparatus 520A.

Referring to FIG. 4, the vibration portion 521 of the second vibration apparatus 520B may include a third hole H3 configured to be adjacent to the signal supply member 530. The third hole H3 may be configured to pass through one side of the vibration portion 521. For example, a third connection portion 573 may be filled in the third hole H3 in the vibration portion 521 of the second vibration apparatus 520B. The third connection portion 573 may be filled in the third hole H3, and thus may electrically connect the second connection member 543 with the second electrode portion 525 of the second vibration apparatus 520B. For example, the third connection portion 573 may electrically connect the second conductive member 543b with the second electrode portion 525 of the second vibration apparatus 520B.

According to the embodiment of the present disclosure, the third hole H3 and the fourth hole H4, which are configured in the vibration portion 521 of each of the first vibration apparatus 520A and the second vibration apparatus 520B, may not overlap each other. Accordingly, the third connection portion 573 and the fourth connection portion 574 may not overlap each other, but the embodiment of the present disclosure is not necessarily limited thereto. For example, the third connection portion 573 and the fourth connection portion 574 may be configured to non-overlap or overlap each other depending on a polarization (or poling) direction of the vibration generating module 500 and the driving signal applied thereto.

In the first vibration apparatus 520A, the first electrode portion 523 may be disposed on the first surface (or upper surface) of the vibration portion 521. In the second vibration apparatus 520B, the first electrode portion 523 may be disposed on the second surface (or lower surface or rear surface) of the vibration portion 521. The first electrode portion 523 may have the same size as the vibration portion 521 or may be smaller than the vibration portion 521.

In the first vibration apparatus 520A, the second electrode portion 525 may be disposed on a second surface (or lower surface) different from or opposite to the first surface of the vibration portion 521. In the second vibration apparatus 520B, the second electrode portion 525 may be disposed on a first surface (or upper surface or front surface) different from or opposite to the second surface of the vibration portion 521. The second electrode portion 525 may have the same size as the vibration portion 521 or may have a smaller size than the vibration portion 521.

One or more of the first electrode portion 523 and the second electrode portion 525 according to an embodiment of the present disclosure may be formed of a transparent conductive material, a semitransparent conductive material, or an opaque conductive material. For example, the transparent conductive material or the semitransparent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), copper (Cu), aluminum (Al), Nickel (Ni), molybdenum (Mo), magnesium (Mg), carbon, or silver (Ag) including glass frit, or the like, or may be made of an alloy thereof, but embodiments of the present disclosure are not limited thereto. For example, to enhance an electrical characteristic and/or a vibration characteristic of the vibration portion 521, each of the first electrode portion 523 and the second electrode portion 525 may include silver (Ag) having a low resistivity. For example, the carbon may include one or more of carbon black, ketjen black, carbon nanotube, and a carbon material including graphite, but embodiments of the present disclosure are not limited thereto.

Referring to FIGS. 1 to 4, each of the first vibration apparatus 520A and the second vibration apparatus 520B may further include auxiliary electrode portions 527 and 528. The auxiliary electrode portions 527 and 528 may be on the first surface or the second surface of the vibration portion 210 so that they may be electrically separated from the first electrode portion 523. Each of the first vibration apparatus 520A and the second vibration apparatus 520B may further include auxiliary electrode portions 527 and 528 electrically separated from the first electrode portion 523 and electrically connected to the second electrode portion 525. For example, the auxiliary electrode portions 527 and 528 may be electrically connected to the second electrode portion 525 by the fourth connection portion 574 and the third connection portion 573 respectively passing through the vibration portion 521. For example, the auxiliary electrode portions 527 and 528 and the first electrode portion 523 may be spaced apart from each other with a gap of 1 mm or less, but the embodiments of the present disclosure are not limited thereto. For example, when a distance between the auxiliary electrode portions 527 and 528 and the first electrode portion 523 is 1 mm or more, since damage to the vibration apparatus 50 may be prevented during a polarization (or poling) process, the auxiliary electrode portion may be formed with a minimum gap.

Referring to FIGS. 1 to 3, the first vibration apparatus 520A may further include a first auxiliary electrode portion 527. The first auxiliary electrode portion 527 may be formed on the same layer as the first electrode portion 523. The first auxiliary electrode portion 527 may be disposed to be spaced apart from the first electrode portion 523. The first auxiliary electrode portion 527 may not be in contact with the first electrode portion 523. The first auxiliary electrode portion 527 may overlap the fourth hole H4. The first auxiliary electrode portion 527 may be provided between the first conductive member 541a of the first connection member 541 and the fourth connection portion 574. For example, the first auxiliary electrode portion 527 may be formed using the same process as that of the first electrode portion 523, but the embodiments of the present disclosure are not limited thereto. For example, in the process of forming the first auxiliary electrode portion 527, a material constituting the first auxiliary electrode portion 527 may be filled in the fourth hole H4 so that the fourth connection portion 574 may be provided. For example, the first electrode portion 523 and the first auxiliary electrode portion 527 and the fourth connection portion 574 of the first vibration apparatus 520A may include the same material, but the embodiments of the present disclosure are not limited thereto. For example, the second electrode portion 525, the fourth connection portion 574, the first auxiliary electrode portion 527, the first conductive member 541a and a first signal line 532a of the first vibration apparatus 520A may be sequentially connected. Accordingly, a driving signal applied to the first signal line 532a may be transferred to the second electrode portion 525 of the first vibration apparatus 520A through the first conductive member 541a of the first connection member 541.

According to another embodiment of the present disclosure, when the first conductive member 541a of the first connection member 541 is welded using a welding material having conductivity, such as lead (Pb), the first auxiliary electrode portion 527 may be omitted. For example, the fourth hole H4 may be filled with the welding material, and the fourth connection portion 574 may include the welding material. Accordingly, the first conductive member 541a of the first connection member 541 may be electrically connected to the second electrode portion 525 of the first vibration apparatus 520A.

Referring to FIGS. 1, 2 and 4, the second vibration apparatus 520B may further include a second auxiliary electrode portion 528. The second auxiliary electrode portion 528 may be formed on the same layer as the first electrode portion 523. The second auxiliary electrode portion 528 may be disposed to be spaced apart from the first electrode portion 523. The second auxiliary electrode portion 528 may not be in contact with the first electrode portion 523. The second auxiliary electrode portion 528 may overlap the third hole H3. The second auxiliary electrode portion 528 may be formed between the second conductive member 543b of the second connection member 543 and the third connection portion 573. For example, the second auxiliary electrode portion 528 may be formed using the same process as that of the first electrode portion 523, but the embodiments of the present disclosure are not limited thereto. For example, in the process of forming the second auxiliary electrode portion 528, a material constituting the second auxiliary electrode portion 528 may be filled in the third hole H3 so that the third connection portion 573 may be provided. For example, the first electrode portion 523 and the second auxiliary electrode portion 528 and the third connection portion 573 of the second vibration apparatus 520B may include the same material, but the embodiments of the present disclosure are not limited thereto. For example, the second electrode portion 525, the third connection portion 573, the second auxiliary electrode portion 528, the second conductive member 543b and a second signal line 532b of the second vibration apparatus 520B may be sequentially connected. Accordingly, a driving signal applied to the second signal line 532b may be transferred to the second electrode portion 525 of the second vibration apparatus 520B through the second conductive member 543b of the second connection member 543.

According to another embodiment of the present disclosure, when the second conductive member 543b of the second connection member 543 is welded using a welding material having conductivity, such as lead (Pb), the second auxiliary electrode portion 528 may be omitted. For example, the third hole H3 may be filled with the welding material, and the third connection portion 573 may include the welding material. Accordingly, the second conductive member 543b of the second connection member 543 may be electrically connected to the second electrode portion 525 of the second vibration apparatus 520B.

According to the present disclosure, since a wire instead of a flexible cable (FFC) for attaching the signal supply member 530 to the vibration apparatus 520 may be configured, the process of the vibration generating module 500 may be simplified. According to the present disclosure, since a hole is provided so that the signal supply member 530 is provided on the upper side of the vibration apparatus 520, cracks due to the FFC may be prevented. According to the present disclosure, a hole may be provided so that the first vibration apparatus 520A and the second vibration apparatus 520B may be simultaneously driven.

Referring to FIGS. 1 to 4, the first auxiliary electrode portion 527 of the first vibration apparatus 520A may overlap the second auxiliary electrode portion 528 of the second vibration apparatus 520B with the vibration member 510 interposed therebetween, or may not overlap the same. For example, the first auxiliary electrode portion 527 and the second auxiliary electrode portion 528 may overlap each other with the vibration member 510 interposed therebetween, or may not overlap each other. According to the embodiment of the present disclosure, for example, the first auxiliary electrode portion 527 and the second auxiliary electrode portion 528 may not overlap each other with the vibration member 510 interposed therebetween.

The vibration portion 521 may be polarized (or poling) by a certain voltage applied to the first electrode portion 523 and the second electrode portion 525 in a certain temperature atmosphere, or a temperature atmosphere that may be changed from a high temperature to a room temperature, but embodiments of the present disclosure are not limited thereto. For example, a polarization direction (or a poling direction) formed in the vibration portion 521 may be formed or aligned (or arranged) from the first electrode portion 523 to the second electrode portion 525, but embodiments of the present disclosure are not limited thereto. For example, the polarization direction (or the poling direction) formed in the vibration portion 521 may be formed or aligned (or arranged) from the second electrode portion 525 to the first electrode portion 523.

The vibration portion 521 may alternately and repeatedly contract and/or expand by an inverse piezoelectric effect based on a driving signal applied to the first electrode portion 523 and the second electrode portion 525 from the outside to vibrate. For example, the vibration portion 521 may vibrate in a vertical direction (or thickness direction) and in a planar direction by the signal applied to the first electrode portion 523 and the second electrode portion 525. The vibration portion 521 may be displaced (or vibrated or driven) by contraction and/or expansion of the planar direction, thereby improving a sound characteristic and/or a sound pressure level characteristic of the vibration generating module 500.

Referring to FIGS. 2 to 4, the vibration generating module 500 according to the embodiment of the present disclosure may further include an adhesive member 550. For example, the vibration apparatus 520 or each of the first vibration apparatus 520A and the second vibration apparatus 520B may be connected to or coupled to the vibration member 510 by an adhesive member 550.

The adhesive member 550 according to the embodiment of the present disclosure may include a first adhesive member 551 and a second adhesive member 553.

The first adhesive member 551 may be disposed (or interposed) between the vibration member 510 and the second vibration apparatus 520B. The second vibration apparatus 520B may be connected to or coupled to the vibration member 510 by the first adhesive member 551. For example, the second vibration apparatus 520B may be connected to or coupled to the second surface (or the lower surface) of the vibration member 510 by the first adhesive member 551.

The second adhesive member 553 may be disposed (or interposed) between the vibration member 510 and the first vibration apparatus 520A. The first vibration apparatus 520A may be connected to or coupled to the vibration member 510 by the second adhesive member 553. For example, the first vibration apparatus 520A may be connected to or coupled to the first surface (or the upper surface) of the vibration member 510 by the second adhesive member 553.

The first adhesive member 551 and the second adhesive member 553 may include an adhesive layer (or a viscosity layer) having excellent adhesion or adhesive force. For example, the first adhesive member 551 and the second adhesive member 553 may include the same or different adhesive layers (or viscosity layers). For example, the first adhesive member 551 and the second adhesive member 553 may include an adhesive, a double-sided adhesive, a double-sided tape, a double-sided adhesive tape, a double-sided adhesive foam tape, a double-sided pad, a double-sided foam pad, a double-sided adhesive foam pad, a double-sided cushion tape or an adhesive sheet, but the embodiments of the present disclosure are not limited thereto.

Referring to FIGS. 1 to 4, the vibration generating module 500 according to an embodiment of the present disclosure may further include a signal supply member 530.

The signal supply member 530 may be configured to supply the driving signal supplied from a driving circuit part to the vibration apparatus 520. The signal supply member 530 may be electrically connected to the pad portion PP on the first surface (or upper surface) of the vibration member 510. The signal supply member 530 may be configured to be connected to the first vibration apparatus 520A and the second vibration apparatus 520B. The signal supply member 530 may be configured to be electrically connected to the first electrode portion 523 and the second electrode portion 525.

A portion of the signal supply member 530 may be accommodated (or inserted) between the first cover member 561 and the second cover member 563. An end portion (or a distal end portion or one side) of the signal supply member 530 may be disposed or inserted (or accommodated) between one edge portion (or one periphery portion) of the first cover member 561 and one edge portion (or one periphery portion) of the second cover member 563. A portion of the signal supply member 530 may be accommodated (or inserted) between the first cover member 561 and the vibration member 510. The end portion (or the distal end portion or the one side) of the signal supply member 530 may be placed or inserted (or accommodated) in a portion between one edge portion of the first cover member 561 and one edge portion of the vibration member 510. The one edge portion of the first cover member 561 and the one edge portion of the vibration member 510 may accommodate or vertically (or up and down) cover the end portion (or the distal end portion or the one side) of the signal supply member 530. Accordingly, the signal supply member 530 may be integrated with the vibration apparatus 520. Accordingly, the vibration generating module 500 may be implemented in a form integrated with the signal supply member 530. For example, the signal supply member 530 may be configured as one part with the vibration apparatus 520, thereby achieving the effect of uni-materialization.

The signal supply member 530 according to an embodiment of the present disclosure may include a base member 531 and a plurality of signal lines 532a and 532b. For example, the signal supply member 530 may include a base member 531, a first signal line 532a, and a second signal line 532b.

The base member 531 may include a transparent or opaque plastic material, but embodiments of the present disclosure are not limited thereto. The base member 531 may have a certain width along a first direction X and may be extended long along a second direction Y intersecting with the first direction X.

The first signal line 532a and the second signal line 532b may be disposed at the first surface of the base member 531 in parallel with the second direction Y and may be spaced apart from each other or electrically separated from each other along the first direction X. The first signal line 532a and the second signal line 532b may be disposed in parallel to each other at the first surface of the base member 531. For example, the first signal line 532a and the second signal line 532b may be implemented in a line shape by patterning of a metal layer (or a conductive layer) formed or deposited at the first surface of the base member 531, but the embodiments of the present disclosure are not limited thereto.

End portions (or distal end portions or one sides) of the first signal line 532a and the second signal line 532b may be separated from each other, and thus, may be individually curved or bent.

Referring to FIGS. 2 and 3, an end portion (or one side) of the first signal line 532a may be electrically connected to the vibration apparatus 520 via a plurality of connection members 540. The first signal line 532a may be electrically connected to the second electrode portion 525 of the first vibration apparatus 520A and the first electrode portion 523 of the second vibration apparatus 520B.

The end portion (or one side) of the first signal line 532a may be connected to the second electrode portion 525 of the first vibration apparatus 520A through the first connection member 541. The end portion (or one side) of the first signal line 532a may be connected to the second electrode portion 525 of the first vibration apparatus 520A through the first conductive member 541a of the first connection member 541. For example, the end portion (or one side) of the first signal line 532a, the first conductive member 541a of the first connection member 541, the fourth connection portion 574, and the second electrode portion 525 of the first vibration apparatus 520A may be sequentially connected.

The end portion (or one side) of the first signal line 532a may be connected to the first electrode portion 523 of the second vibration apparatus 520B through the first connection member 541, the first connection portion 571 and the second connection member 543. The end portion (or one side) of the first signal line 532a may be connected to the first electrode portion 523 of the second vibration apparatus 520B through the first conductive member 541a of the first connection member 541, the first connection portion 571, and the first conductive member 543a of the second connection member 543. For example, the end portion (or one side) of the first signal line 532a, the first conductive member 541a of the first connection member 541, the first connection portion 571, the first conductive member 543a of the second connection member 543, and the first electrode portion 523 of the second vibration apparatus 520B may be sequentially connected.

Accordingly, the first signal line 532a may apply the same signal to the second electrode portion 525 of the first vibration apparatus 520A and the first electrode portion 523 of the second vibration apparatus 520B. Accordingly, the first signal line 532a may supply a first driving signal supplied from a driving circuit portion to the second electrode portion 525 of the first vibration apparatus 520A and the first electrode portion 523 of the second vibration apparatus 520B.

Referring to FIGS. 2 and 4, the end portion (or one side) of the second signal line 532b may be electrically connected to the vibration apparatus 520 via a plurality of connection members 540. The second signal line 532b may be electrically connected to the first electrode portion 523 of the first vibration apparatus 520A and the second electrode portion 525 of the second vibration apparatus 520B.

The end portion (or one side) of the second signal line 532b may be connected to the second electrode portion 525 of the first vibration apparatus 520A through the first connection member 541. The end portion (or one side) of the second signal line 532b may be connected to the first electrode portion 523 of the first vibration apparatus 520A through the second conductive member 541b of the first connection member 541. For example, the end portion (or one side) of the second signal line 532b, the second conductive member 541b of the first connection member 541, and the first electrode portion 523 of the first vibration apparatus 520A may be sequentially connected.

The end portion (or one side) of the second signal line 532b may be connected to the second electrode portion 525 of the second vibration apparatus 520B through the first connection member 541, the second connection portion 572 and the second connection member 543. The end portion (or one side) of the second signal line 532b may be connected to the second electrode portion 525 of the second vibration apparatus 520B through the second conductive member 541b of the first connection member 541, the second connection portion 572, and the second conductive member 543b of the second connection member 543. For example, the end portion (or one side) of the second signal line 532b, the second conductive member 541b of the first connection member 541, the second connection portion 572, the second conductive member 543b of the second connection member 543, the second auxiliary electrode portion 528, the third connection portion 573, and the second electrode portion 525 of the second vibration apparatus 520B may be sequentially connected.

Accordingly, the second signal line 532b may apply the same signal to the first electrode portion 523 of the first vibration apparatus 520A and the second electrode portion 525 of the second vibration apparatus 520B. Accordingly, the second signal line 532b may supply a second driving signal supplied from the driving circuit portion to the first electrode portion 523 of the first vibration apparatus 520A and the second electrode portion 525 of the second vibration apparatus 520B.

According to an embodiment of the present disclosure, a portion of the signal supply member 530 or a portion of the base member 531 may be disposed or inserted (or accommodated) between the first cover member 561 and the vibration member 510, and thus, the signal supply member 530 may be integrated (or configured) as one body with the vibration member 510 and the vibration apparatus 520. Accordingly, the vibration apparatus 520 and the signal supply member 530 may be configured as one part (or one component), and thus, an effect of uni-materialization may be obtained.

According to an embodiment of the present disclosure, the first signal line 532a and the second signal line 532b of the signal supply member 530 may be integrated (or configured) as one body with the vibration member 510 and the vibration apparatus 520, and thus, a soldering process for an electrical connection between the vibration apparatus 520 and the signal supply member 530 may not be needed. Accordingly, a manufacturing process and a structure of the vibration apparatus 520 may be simplified, and hazards associated with the soldering process may be reduced.

Referring to FIGS. 3 and 4, the vibration generating module 500 according to an embodiment of the present disclosure may further include a cover member 560. The cover member 560 may include a first cover member 561 and a second cover member 563.

A first cover member 561 may be disposed on the first surface (or upper surface) of the vibration member 510. The first cover member 561 may be disposed on the first surface (or upper surface) of the vibration apparatus 520. The first cover member 561 may be included in the first vibration apparatus 520A, the pad portion PP, and a portion of the signal supply member 530, and may be provided on the first surface (or upper surface) of the vibration member 510. For example, the first cover member 561 may be provided on the first surface (or upper surface) of the vibration member 510 to cover the first vibration apparatus 520A, the pad portion PP, and a portion of the signal supply member 530.

The first cover member 561 may be provided on the first electrode portion 523 of the first vibration apparatus 520A. For example, the first cover member 561 may be provided to cover the first electrode portion 523 of the first vibration apparatus 520A. The first cover member 561 may be provided on the first connection member 541. For example, the first cover member 561 may be provided to cover the first connection member 541. For example, the first cover member 561 may be provided to have a size larger than that of the vibration apparatus 520, but the embodiments of the present disclosure are not limited thereto. The first cover member 561 may be provided to protect the first surface (or upper surface) of the vibration apparatus 520 and the first electrode portion 523 of the first vibration apparatus 520A.

A second cover member 563 may be disposed on the second surface (or lower surface) of the vibration member 510. The second cover member 563 may be disposed on the second surface (or lower surface) of the vibration apparatus 520. The second cover member 563 may be included in the second vibration apparatus 520B, the pad portion PP, and a portion of the signal supply member 530, and may be provided on the second surface (or lower surface) of the vibration member 510. For example, the second cover member 563 may be provided on the second surface (or lower surface) of the vibration member 510 to cover the second vibration apparatus 520B, the pad portion PP, and a portion of the signal supply member 530. The second cover member 563 may be provided on the first electrode portion 523 of the second vibration apparatus 520B. For example, the second cover member 563 may be provided to cover the first electrode portion 523 of the second vibration apparatus 520B. The second cover member 563 may be provided on the second connection member 543. For example, the second cover member 563 may be provided to cover the second connection member 543. For example, the second cover member 563 may be provided to have a size larger than that of the vibration apparatus 520, but the embodiments of the present disclosure are not limited thereto. The second cover member 563 may be provided to protect the second surface (or lower surface) of the vibration apparatus 520 and the first electrode portion 523 of the second vibration apparatus 520B.

The first cover member 561 and the second cover member 563 according to an embodiment of the present disclosure may include a same material or a different material. For example, each of the first cover member 561 and the second cover member 563 may be a polyimide (PI) film, a polyethylene terephthalate (PET) film, or a polyethylene naphthalate (PEN) film, but embodiments of the present disclosure are not limited thereto. For example, each of the first cover member 561 and the second cover member 563 may be provided to be formed of or coated with a non-conductive material, but the embodiments of the present disclosure are not limited thereto.

The first cover member 561 may be connected or coupled to the first surface of the vibration apparatus 520 or the first electrode portion 523 of the first vibration apparatus 520A by a first adhesive layer 561-1. For example, the first cover member 561 may be connected or coupled to the first surface or the first electrode portion 523 of the first vibration apparatus 520A by a film laminating process using the first adhesive layer 561-1.

The second cover member 563 may be connected or coupled to the second surface of the vibration apparatus 520 or the first electrode portion 523 of the second vibration apparatus 520B by a second adhesive layer 563-1. For example, the second cover member 563 may be connected or coupled to the second surface of the vibration apparatus 520 or the first electrode portion 523 of the second vibration apparatus 520B by a film laminating process using the second adhesive layer 563-1.

Each of the first adhesive layer 561-1 and second adhesive layer 563-1 according to an embodiment of the present disclosure may include an electrically insulating material which has adhesiveness and is capable of compression and decompression. For example, each of the first adhesive layer 561-1 and the second adhesive layer 563-1 may include an epoxy resin, an acrylic resin, a silicone resin, a urethane resin, an acrylic series polymer, a silicone series polymer, or a urethane series polymer, but embodiments of the present disclosure are not limited thereto.

A first adhesive layer 561-1 and a second adhesive layer 563-1 may be configured between the first cover member 561 and the second cover member 563. For example, the first adhesive layer 561-1 and the second adhesive layer 563-1 may be provided between the first cover member 561 and the second cover member 563 to surround the vibration apparatus 520 and the plurality of connection members 540. For example, one or more of the first adhesive layer 561-1 and the second adhesive layer 563-1 may be provided to partially or completely surround the vibration apparatus 520 and the plurality of connection members 540.

The embodiment of the present disclosure may include a plurality of connection members 540. The plurality of connection members 540 may electrically connect the vibration apparatus 520 with the signal supply member 530. The plurality of connection members 540 may include a first connection member 541 and a second connection member 543.

Referring to FIGS. 2 to 4, the first connection member 541 may be provided on the first surface (or upper surface) of the vibration member 510. The first connection member 541 may be electrically connected to the pad portion PP and the first vibration apparatus 520A. The first connection member 541 may be electrically connected to each of the first auxiliary electrode portion 527 and the first electrode portion 523 of the first vibration apparatus 520A and the pad portion PP. The first connection member 541 may include a first conductive member 541a and a second conductive member 541b.

The first conductive member 541a may be provided on the first surface (or upper surface) of the vibration member 510. The first conductive member 541a may be electrically connected to the first auxiliary electrode portion 527 of the first vibration apparatus 520A and the first connection portion 571. One end of the first conductive member 541a may be electrically connected to the first signal line 532a. The other end of the first conductive member 541a may be electrically connected to the second electrode portion 525 of the first vibration apparatus 520A through the fourth connection portion 574. Accordingly, the first conductive member 541a may electrically connect the first signal line 532a to the second electrode portion 525 of the first vibration apparatus 520A. As a result, the first signal line 532a may transfer the first driving signal supplied from the driving circuit portion to the second electrode portion 525 of the first vibration apparatus 520A.

The second conductive member 541b may be configured on the first surface (or upper surface) of the vibration member 510. The second conductive member 541b may be provided to be parallel with the first conductive member 541a. The second conductive member 541b may be electrically connected to the first electrode portion 523 of the first vibration apparatus 520A and the second connection portion 572. One end of the second conductive member 541b may be electrically connected to the second signal line 532b. The other end of the second conductive member 541b may be electrically connected to the first electrode portion 523 of the first vibration apparatus 520A. Accordingly, the second conductive member 541b may electrically connect the second signal line 532b to the first electrode portion 523 of the first vibration apparatus 520A. As a result, the second signal line 532b may transfer the second driving signal supplied from the driving circuit portion to the first electrode portion 523 of the first vibration apparatus 520A.

Referring to FIGS. 2 to 4, the second connection member 543 may be formed on the second surface (or lower surface) of the vibration member 510. The second connection member 543 may be electrically connected to the pad portion PP and the second vibration apparatus 520B. The second connection member 543 may be electrically connected to each of the second auxiliary electrode portion 528 and the first electrode portion 523 of the second vibration apparatus 520B and the pad portion PP. The second connection member 543 may include a first conductive member 543a and a second conductive member 543b.

The first conductive member 543a of the second connection member 543 may be provided on the second surface (or lower surface) of the vibration member 510. The first conductive member 543a may be electrically connected to the first electrode portion 523 of the second vibration apparatus 520B and the first connection portion 571. One end (or one side) of the first conductive member 543a may be electrically connected to the first signal line 532a through the first connection portion 571 and the first conductive member 541a of the first connection member 541. The other end (or the other side) of the first conductive member 543a may be electrically connected to the first electrode portion 523 of the second vibration apparatus 520B. Accordingly, the first conductive member 541a may electrically connect the first signal line 532a to the first electrode portion 523 of the second vibration apparatus 520B. As a result, the first signal line 532a may transfer the first driving signal supplied from the driving circuit portion to the first electrode portion 523 of the second vibration apparatus 520B.

The second conductive member 543b of the second connection member 543 may be provided on the second surface (or lower surface) of the vibration member 510. The second conductive member 543b may be provided to be parallel with the first conductive member 543a. The second conductive member 543b may be electrically connected to the second auxiliary electrode portion 528 of the second vibration apparatus 520B and the second connection portion 572. One end (or one side) of the second conductive member 543b may be electrically connected to the second signal line 532b through the second connection portion 572 and the second conductive member 541b of the first connection member 541. The other end (or the other side) of the second conductive member 543b may be electrically connected to the second electrode portion 525 of the second vibration apparatus 520B through the second auxiliary electrode portion 528 and the third connection portion 573. Accordingly, the second conductive member 543b may electrically connect the second signal line 532b to the second electrode portion 525 of the second vibration apparatus 520B. As a result, the second signal line 532b may transfer the second driving signal supplied from the driving circuit portion to the second electrode portion 525 of the second vibration apparatus 520B.

According to the embodiment of the present disclosure, the first conductive members 541a and 543a of the first connection member 541 and the second connection member 543 may overlap each other. For example, the first conductive members 541a and 543a of the first connection member 541 and the second connection member 543 may be electrically connected to each other through the first connection portion 571. Accordingly, the first driving signal applied to the first signal line 532a may be supplied to the second electrode portion 525 of the first vibration apparatus 520A and the first electrode portion 523 of the second vibration apparatus 520B.

According to the embodiment of the present disclosure, the second conductive members 541b and 543b of the first connection member 541 and the second connection member 543 may overlap each other. For example, the second conductive members 541b and 543b of the first connection member 541 and the second connection member 543 may be electrically connected to each other through the second connection portion 572. Accordingly, the second driving signal applied to the second signal line 532b may be supplied to the first electrode portion 523 of the first vibration apparatus 520A and the second electrode portion 525 of the second vibration apparatus 520B.

According to the embodiment of the present disclosure, the first driving signal applied to the first signal line 532a may be a negative (−) polarity signal, and the negative (−) polarity signal may be supplied to the second electrode portion 525 of the first vibration apparatus 520A and the first electrode portion 523 of the second vibration apparatus 520B. The second driving signal applied to the second signal line 532b may be a positive (+) polarity signal, and the positive (+) polarity signal may be supplied to the first electrode portion 523 of the first vibration apparatus 520A and the second electrode portion 525 of the second vibration apparatus 520B.

According to another embodiment of the present disclosure, the first driving signal applied to the first signal line 532a may be a positive (+) polarity signal, and the positive (+) polarity signal may be supplied to the second electrode portion 525 of the first vibration apparatus 520A and the first electrode portion 523 of the second vibration apparatus 520B. The second driving signal applied to the second signal line 532b may be a negative (−) polarity signal, and the negative (−) polarity signal may be supplied to the first electrode portion 523 of the first vibration apparatus 520A and the second electrode portion 525 of the second vibration apparatus 520B.

According to the embodiment of the present disclosure, the first connection member 541 and the second connection member 543 may include a conductive tape or lead (Pb). For example, the first conductive members 541a and 543a and the second conductive members 541b and 543b may include a conductive tape or lead (Pb), but are not limited thereto.

According to the embodiment of the present disclosure, the vibration generating module 500 includes the pad portion PP that includes the connection portion 570 in the vibration member 510, and includes a plurality of connection members 540 connecting the vibration apparatus 520 with the signal supply member 530, thereby obtaining the effect of simplifying the structure of the vibration generating module 500 and reducing volume and thickness.

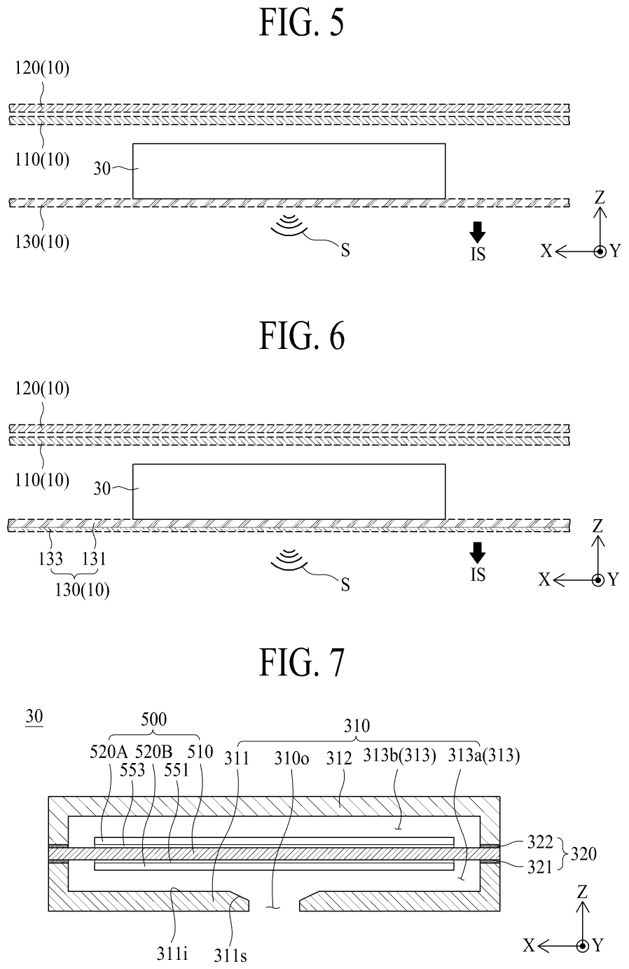

FIG. 5 is a view illustrating a sound apparatus according to the embodiment of the present disclosure. For example, FIG. 5 illustrates a vehicular sound apparatus according to an embodiment of the present disclosure.

Referring to FIG. 5, a sound apparatus 30 according to an embodiment of the present disclosure may be disposed or equipped at an inner portion of a vehicle 10 to output a sound S toward an indoor space IS of the vehicle 10.

The vehicle 10 may be a vehicular apparatus including one or more seats and one or more windows. For example, the vehicle 10 may include an automobile, a train, a ship, or an aircraft, but the embodiments of the present disclosure are not limited thereto.

The vehicle 10 according to an embodiment of the present disclosure may include a main structure 110.

The main structure 110 of the vehicle 10 may include a main frame, a sub-frame, a side frame, a door frame, an under frame, a seat frame, etc., but the embodiments of the present disclosure are not limited thereto. For example, the main structure 110 may be a body, a vehicle structure, a frame structure, etc., but the embodiments of the present disclosure are not limited thereto.

The vehicle 10 according to the embodiment of the present disclosure may further include an exterior material 120.

The exterior material 120 of the vehicle 10 may be configured to cover the main structure 110. For example, the exterior material 120 may be configured to cover the exterior of the main structure 110. In the following description, the exterior material 120 may be a vehicle exterior material 120, and these may be used interchangeably.

The exterior material 120 of the vehicle 10 may include a hood panel, a front fender panel, a dash panel, a pillar panel, a trunk panel, a roof panel (or a ceiling), a floor panel, a door inner panel, a door outer panel, and the like, but the embodiments of the present disclosure are not limited thereto.

The exterior material 120 according to the embodiment of the present disclosure may include at least one of a flat portion and a curved portion (or a bent portion). For example, the exterior material 120 may have a structure corresponding to the structure of the corresponding main structure 110 or may have a structure different from the structure of the corresponding main structure 110.

The vehicle 10 according to the embodiment of the present disclosure may further include an interior material 130. In the following description the interior material 130 may be referred to as a vehicle interior material 130, and these may be used interchangeably.

The vehicle interior material 130 may include all elements configuring an inner portion of the vehicle 10, or may include all elements disposed at the indoor space IS of the vehicle 10. For example, the vehicle interior material 130 may be an interior member or an inner finish material of the vehicle 10, but embodiments of the present disclosure are not limited thereto.

The vehicle interior material 130 according to the embodiment of the present disclosure may be configured to cover at least one of the main structure 110 and the exterior material 120 in the indoor space IS of the vehicle 10. For example, the interior material 130 may be configured to be exposed to the indoor space IS of the vehicle 10 while covering at least one of the main structure 110 and the exterior material 120 in the indoor space IS of the vehicle 10.

The vehicle interior material 130 according to an embodiment of the present disclosure may be exposed to the inner portion or the indoor space IS of the vehicle 10 in the inner portion or the indoor space IS of the vehicle 10. For example, the vehicle interior material 130 may be configured to cover one surface (or an interior surface) of at least one or more of a main frame (or a vehicle body), a side frame (or a side body), a door frame (or a door body), a handle frame (or a steering hub), and a seat frame, which are exposed to the indoor space IS of the vehicle 10.

The vehicle interior material 130 according to an embodiment of the present disclosure may include a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an indoor illumination interior material), a rear view mirror, a glove box, and a sun visor, or the like, but embodiments of the present disclosure are not limited thereto.

The vehicle interior material 130 according to an embodiment of the present disclosure may include one or more materials of metal, wood, rubber, plastic, glass, fiber, cloth, paper, a mirror, leather, and carbon, but embodiments of the present disclosure are not limited thereto. The vehicle interior material 130 including a plastic material may be an injection material which is implemented by an injection process using a thermoplastic resin or a thermosetting resin, but embodiments of the present disclosure are not limited thereto. The vehicle interior material 130 including a fiber material may include at least one or more of a plastic composite fiber, a carbon fiber (or an aramid fiber), and a natural fiber, but embodiments of the present disclosure are not limited thereto. The vehicle interior material 130 including the fiber material may include a textile sheet, a knit sheet, or a nonwoven fabric, or the like, but embodiments of the present disclosure are not limited thereto. For example, the paper may be cone paper for speakers. For example, the cone paper may be pulp or foamed plastic, or the like, but embodiments of the present disclosure are not limited thereto. The vehicle interior material 130 including a leather material may include natural leather or artificial leather, but embodiments of the present disclosure are not limited thereto.

The vehicle interior material 130 according to an embodiment of the present disclosure may include at least one or more of a flat portion (or flat surface portion) and a curved portion (or curved surface portion). For example, the vehicle interior material 130 may have a surface structure corresponding to a surface structure of a corresponding vehicle structure, or may have a surface structure which differs from a surface structure of a corresponding vehicle structure.

According to an embodiment of the present disclosure, the sound apparatus 30 may be disposed at the vehicle interior material 130. The sound apparatus 30 may vibrate the vehicle interior material 130 to generate a sound S based on a vibration of the vehicle interior material 130. For example, the sound apparatus 30 may directly vibrate the vehicle interior material 130 to generate the sound S based on a vibration of the vehicle interior material 130. For example, the sound apparatus 30 may be configured to vibrate the vehicle interior material 130 to output the sound S toward an inner portion or an indoor space IS of the vehicle 10. Thus, the sound apparatus 30 may use the vehicle interior material 130 as a sound vibration plate or an acoustic diaphragm. The vehicle interior material 130 may perform a function of a vibration plate, a sound vibration plate, or a sound generating plate for outputting the sound S. For example, the vehicle interior material 130 may have a size which is greater than the sound apparatus 30, but embodiments of the present disclosure are not limited thereto.

According to an embodiment of the present disclosure, the sound apparatus 30 may be disposed at least one or more of a dashboard, a pillar interior material, a floor interior material, a roof interior material, a door interior material, a handle interior material, and a seat interior material, or may be positioned or connected (or coupled) to at least one of a rear package interior material, an overhead console, a rear view mirror, a glove box, and a sun visor. For example, the sound apparatus 30 may be configured to vibrate (or directly vibrate) at least one or more of a dashboard, a pillar interior material, a floor interior material, a roof interior material, a door interior material, a handle interior material, a seat interior material, a rear package interior material, an overhead console, a rear view mirror, a glove box, and a sun visor to output sound S toward the interior and/or indoor space IS of the vehicle 10.

A vehicle 10 according to an embodiment of the present disclosure may include one or more sound apparatus 30 arranged or connected to at least one area (or part) of a vehicle interior material 130. The one or more sound apparatus 30 may vibrate at least one area (or part) of the vehicle interior material 130 to output realistic sound S and/or stereo sound including multi-channels toward the indoor space IS of the vehicle 10.

According to an embodiment of the present disclosure, the sound apparatus 30 may be configured in an area between the vehicle interior material 130 and the main structure 110 or an area between the vehicle interior material 130 and the exterior material 120. The sound apparatus 30 is placed in an area between the vehicle interior material 130 and the main structure 110 or an area between the vehicle interior material 130 and the exterior material 120, and may output sound S by indirectly or directly vibrating at least one of the areas between the vehicle interior material 130 and the main structure 110 or the areas between the vehicle interior material 130 and the exterior material 120.

According to an embodiment of the present disclosure, the sound apparatus 30 may be arranged in one or more of the region (or first region) between the main structure 110 and the exterior material 120, the region (or second region) between the main structure 110 and the vehicle interior material 130, the exterior material 120, and the vehicle interior material 130. For example, the sound apparatus 30 may be arranged in one or more of the region (or first region) between the main structure 110 and the exterior material 120, the region (or second region) between the main structure 110 and the vehicle interior material 130, the exterior material 120, and the vehicle interior material 130, and may be configured to output sound. For example, the sound device 30 is placed in one or more of the area between the main structure 110 and the exterior material 120 (or the first area), the area between the main structure 110 and the vehicle interior material 130 (or the second area), the exterior material 120, and the vehicle interior material 130, and may output sound by indirectly or directly vibrating one or more of the main structure 110, the exterior material 120, and the vehicle interior material 130.

According to an embodiment of the present disclosure, the sound apparatus 30 may be configured to output sound between the exterior material 120 and the interior material 130 of the vehicle 10. For example, the sound apparatus 30 may be disposed in at least one of a region (or a third region) between the exterior material 120 and the interior material 130, the exterior material 120, and the interior material 130. For example, the sound apparatus 30 may be disposed between the exterior material 120 and the interior material 130, and may indirectly or directly vibrate at least one of the exterior material 120 and the interior material 130 to output sound. For example, the sound apparatus 30 is connected or coupled between the exterior material 120 and the vehicle interior material 130 and at least one of the exterior material 120 and the vehicle interior material 130, and may output sound by indirectly or directly vibrating at least one of the exterior material 120 and the vehicle interior material 130. For example, at least one of the exterior material 120 and the vehicle interior material 130 may output sound S according to the driving (or vibration or displacement) of at least one sound apparatus 30.

According to an embodiment of the present disclosure, at least one of the exterior material 120 and the interior material 130 of the vehicle 10 may be a vibration plate, an acoustic vibration plate, or a sound generating plate for outputting sound S. For example, since each of the exterior material 120 and the vehicle interior material 130 for outputting sound S has a larger size (or area) than the sound apparatus 30, it may function as a large-area vibration plate, acoustic vibration plate, or sound generating plate, thereby improving acoustic characteristics and/or sound pressure characteristics of a sound range including a low-pitched sound range generated by the sound apparatus 30. For example, the sound frequency of the low-pitched sound range may be 300 Hz or less, 400 Hz or less, or 500 Hz or less, but the embodiments of the present disclosure are not limited thereto.

FIG. 6 is a view illustrating a sound apparatus according to another embodiment of the present disclosure. FIG. 6 illustrates an embodiment implemented by modifying the vehicle interior material 130 on which the sound apparatus described above with reference to FIG. 5 is disposed. Therefore, in the following description, repetitive descriptions of elements other than a vehicle interior material 130 are omitted or will be briefly given.

Referring to FIG. 6, the sound apparatus 30 according to another embodiment of the present disclosure may vibrate a vehicle interior material 130 to output sound S.

The vehicle interior material 130 according to anther embodiment of the present disclosure may include one or more materials of metal, wood, rubber, plastic, glass, fiber, cloth, paper, a mirror, a leather and carbon, but embodiments of the present disclosure are not limited thereto.

The vehicle interior material 130 according to another embodiment of the present disclosure may include a bottom member 131 and a surface member 133. For example, the bottom member 131 may be an injection material, a first interior material, an inner interior material, or a rear interior material, but embodiments of the present disclosure are not limited thereto. The surface member 133 may be a second interior material, an outer interior material, a front interior material, an outer surface member, a reinforcement member, or a decoration member, but embodiments of the present disclosure are not limited thereto.

The bottom member 131 may include a plastic material, but embodiments of the present disclosure are not limited thereto. The bottom member 131 according to an embodiment of the present disclosure may include an injection material. For example, the bottom member 131 may be an injection material which is implemented by an injection process using a thermoplastic resin or a thermosetting resin, but embodiments of the present disclosure are not limited thereto. The vehicle interior material 130 or the bottom member 131 may be configured to cover an inner portion of a vehicle 10. For example, the vehicle interior material 130 or the bottom member 131 may be configured to cover at least one of the main structure 110 and the exterior material 120 in the indoor space IS of the vehicle 10. For example, the vehicle interior material 130 or the bottom member 131 may be configured to cover one surface (or an inner surface) of at least one or more of a main frame, a side frame, a door frame, and a handle frame, which are exposed to the indoor space IS of the vehicle 10.

The bottom member 131 may include one or more of a flat portion and a curved portion. For example, the bottom member 131 may have a surface structure corresponding to a surface structure of a corresponding vehicle structure, or may have a surface structure which differs from a surface structure of a corresponding vehicle structure.

The surface member 133 may be disposed on the bottom member 131. The surface member 133 may cover the bottom member 131 at the inner portion or the indoor space IS of the vehicle 10 and may be exposed at the inner portion or the indoor space IS of the vehicle 10. For example, the surface member 133 may be disposed at or coupled to a front surface (or an interior surface) of the bottom member 131 exposed at the indoor space IS of the vehicle 10.

The vehicle interior material 130 or the surface member 133 according to an embodiment of the present disclosure may include one or more materials of a fiber, leather, cloth, and wood, but embodiments of the present disclosure are not limited thereto. For example, the surface member 133 may be a fiber material. For example, the surface member 133 including a fiber material may include one or more of a synthetic fiber, a carbon fiber (or an aramid fiber), and a natural fiber, but embodiments of the present disclosure are not limited thereto. For example, the surface member 133 including the fiber material may be a textile sheet, a knit sheet, or a nonwoven fabric, but embodiments of the present disclosure are not limited thereto. For example, the surface member 133 including the fiber material may be a fabric member, but embodiments of the present disclosure are not limited thereto.

The synthetic fiber may be a thermoplastic resin and may include a polyolefin-based fiber which is an eco-friendly material which does not relatively release a harmful substance. For example, the polyolefin-based fiber may include a polyethylene fiber, a polypropylene fiber, or a polyethylene terephthalate fiber, but embodiments of the present disclosure are not limited thereto. The polyolefin-based fiber may be a fiber of a single resin or a fiber of a core-shell structure, but embodiments of the present disclosure are not limited thereto. The natural fiber may be a composite fiber of one or two or more of a jute fiber, a kenaf fiber, an abaca fiber, a coconut fiber, and a wood fiber, but embodiments of the present disclosure are not limited thereto.

The sound apparatus 30 may be covered by the vehicle interior material 130. The sound apparatus 30 may be configured to vibrate the vehicle interior material 130 including the bottom member 131 and the surface member 133 to output a sound S toward the inner portion or the indoor space IS of the vehicle 10.

The sound apparatus 30 according to another embodiment of the present disclosure may output the sound S toward the indoor space IS of the vehicle 10 by using the vehicle interior material as a vibration plate or a sound vibration plate and may output a realistic sound S or stereo sound including a multichannel toward the indoor space IS of the vehicle 10.

According to another embodiment of the present disclosure, the sound apparatus 30 may be surrounded by an enclosure. A space may be provided between the sound apparatus 30 and the enclosure, and a sound (or a sound pressure level) may be output based on a vibration of the vehicle interior material 130 based on air between the sound apparatus 30 and the enclosure. However, there may be a problem where a sound of the low-pitched sound band is not output, and there may be a problem where the flatness of a sound pressure level is reduced because the number of peaks and dips occurring in a reproduction frequency band of a sound (or a sound pressure level) generated based on a vibration of the vehicle interior material 130 increases and each of a highest sound pressure level and a lowest sound pressure level occurring in a reproduction frequency band of a sound (or a sound pressure level) generated based on a vibration of the vehicle interior material 130 increases. The peak may be a phenomenon where a sound pressure level bounces in a specific frequency, and the dip may be a phenomenon where a low sound pressure level is generated as the occurrence of a sound having a specific frequency is reduced. The flatness of a sound characteristic may be a level of a deviation between a highest sound pressure and a lowest sound pressure.

FIG. 7 is a cross-sectional view illustrating a sound apparatus according to the embodiment of the present disclosure.

Referring to FIG. 7, a sound apparatus 30 (or a vehicle sound apparatus) according to the embodiment of the present disclosure may be configured to vibrate a vibration target or a vehicle structure. For example, the sound apparatus 30 may be a sound generating apparatus, a sound output apparatus, a speaker apparatus, a car audio apparatus, or an audio apparatus, but the embodiments of the present disclosure are not limited thereto.

The sound apparatus 30 may be configured to be connected (or coupled) to the vibration target or the vehicle structure. For example, the sound apparatus 30 may be disposed in (or connected to) a portion of any one of a main structure 110, an exterior material 120 and a vehicle interior material 130, which are shown in FIG. 5 or FIG. 6, to generate (or output) sound. For example, the sound apparatus 30 may be configured to vibrate any one of the main structure 110, the exterior material 120 and the vehicle interior material 130, which are shown in FIG. 5 or FIG. 6, to generate (or output) sound.

The sound apparatus 30 according to the embodiment of the present disclosure may include an enclosure 310 and a vibration generating module 500. Since the description of the vibration generating module 500 according to the embodiment of the present disclosure is substantially the same as that described in FIGS. 1 to 4, the same reference numerals will be given, and their redundant description will be omitted.

According to the embodiment of the present disclosure, the enclosure 310 may include at least one enclosure. At least one enclosure may include a first enclosure 311 and a second enclosure 312. For example, the second enclosure 312 may be connected to the first enclosure 311. For example, the enclosure 310 may be a housing, a case, an outer case, a case member, a housing member, a cabinet, a sealing member, a sealing cap, a sealing box, or a sound box, and the embodiments of the present disclosure are not limited thereto.

The enclosure 310 according to the embodiment of the present disclosure may include one or more of a metallic material and a non-metallic material (or composite non-metallic material), but the embodiments of the present disclosure are not limited thereto. For example, the enclosure 310 may include one or more of a metallic material, plastic and wood, but the embodiments of the present disclosure are not limited thereto. For example, the enclosure 310 may be made of a metallic material of an aluminum material or a plastic material of a styrene material, but the embodiments of the present disclosure are not limited thereto. For example, the styrene material may be an ABS material. The ABS material may be acrylonitrile, butadiene, and styrene.

The enclosure 310 may include an inner space 313. The inner space 313 may be between the first enclosure 311 and the second enclosure 312. For example, the vibration generating module 500 may be provided in the inner space 313 of the enclosure 310. For example, the vibration generating module 500 may be provided in the inner space 313 between the first enclosure 311 and the second enclosure 312. The vibration apparatus of the vibration generating module 500 may be in the inner space 313 of the enclosure 310. For example, the first vibration apparatus 520A and the second vibration apparatus 520B of the vibration apparatus may be in the inner space 313 of the enclosure 310. The first vibration apparatus 520A and the second vibration apparatus 520B may be in spaces different from each other in the inner space 313 of the enclosure 310. For example, the first vibration apparatus 520A may be in a first space 313a. For example, the first vibration apparatus 520A may be between the first enclosure 311 and the vibration member 510. For example, the second vibration apparatus 520B may be in a second space 313b. For example, the second vibration apparatus 520B may be between the second enclosure 312 and the vibration member 510. For example, the inner space 313 may be an accommodation space, a receiving space, a gap space, an air space, a vibration space, a sound space, a soundbox, or a sealed space, and the embodiments of the present disclosure are not limited thereto.

According to the embodiment of the present disclosure, the inner space 313 of the enclosure 310 may include a first space 313a and a second space 313b. For example, the first space 313a may be between a first surface of the vibration generating module 500 and the first enclosure 311. The first space 313a may be between the first vibration apparatus 520A and the first enclosure 311. For example, the second space 313b may be between the second enclosure 312 and a second surface that is different from (or opposite to) the first surface of the vibration generating module 500. The second space 313b may be between the second vibration apparatus 520B and the second enclosure 312. For example, the inner space 313 may be a gap space, an air gap, a vibration space, a sound space, a soundbox, or a sealed space, and the embodiments of the present disclosure are not limited thereto.

According to the embodiment of the present disclosure, the first enclosure 311 may include an opening portion 3100.

The opening portion 3100 may be provided to pass through (or vertically pass through) the first enclosure 311 in a thickness direction Z (or vertical direction) of the enclosure 310. The opening portion 3100 may be connected to the inner space 313. For example, the opening portion 3100 may be configured to reduce an air pressure in the inner space 313 of the enclosure 310. For example, the opening portion 3100 may be connected to the first space 313a. The opening portion 3100 may be configured to reduce an air pressure in the first space 313a of the first enclosure 311 or in the first space 313a provided between the vibration member 510 and the first enclosure 311. In this case, since a low-pitched band may be expanded, its sound characteristics may be improved. For example, as the pressure (or air pressure) of the first space 313a is lowered by the opening portion 3100, the displacement amount (or bending force) of the first vibration apparatus 520 disposed between the vibration member 510 and the first enclosure 311 may be increased, whereby the low-pitched band may be expanded, and its sound characteristics and/or sound pressure characteristics may be improved. Accordingly, sound (or sound pressure) of the low-pitched band, which is generated in accordance with vibration of the first vibration apparatus 520A and/or the second vibration apparatus 335B, may be improved.

According to the embodiment of the present disclosure, the opening portion 3100 may be smaller than a size of the first vibration apparatus 520A. For example, the opening portion 3100 may be smaller than the size of the first vibration apparatus 520A disposed in the vibration generating module 500. For example, the opening portion 3100 may have a line shape having a size (or length) smaller than the size of the first vibration apparatus 520A disposed in the vibration generating module 500. For example, the opening portion 3100 may be a hole, a slot, or a slit, and the embodiments of the present disclosure are not limited thereto. For example, the opening portion 3100 may be a sound emission unit, a sound emission port, a sound output unit, a sound output port, a sound output hole, or a vent hole, and the embodiments of the present disclosure are not limited thereto.

The opening portion 3100 may be a space in which sound waves generated in accordance with the vibration of the vibration generating module 500 are propagated (or transferred) to an indoor space of a vehicle. Accordingly, since a vibration width (or displacement width) of the vibration member 510 according to the vibration of the vibration generating module 500 may be increased, sound characteristics and/or sound pressure characteristics generated in accordance with the vibration of the vibration member 510 may be improved.

The first enclosure 311 may be disposed to be more adjacent to the vehicle interior material than to the second enclosure 312. For example, the first enclosure 311 including the opening portion 3100 may be disposed to be more adjacent to the vehicle interior than to the second enclosure 312. Accordingly, since sound generated by vibration of one or more of the first vibration apparatus 520A and the second vibration apparatus 520B may be output to the indoor space of the vehicle, sound including a low-pitched band may be output to the indoor space of the vehicle.

The first enclosure 311 may include an inclined surface 311s and an inner side 311i. The inclined surface 311s may be configured to be inclined between the inner side 311i of the first enclosure 311 and the opening portion 3100. The inclined surface 311s may be configured to guide sound generated in accordance with vibration of the vibration generating module 500 to the indoor space of the vehicle. Accordingly, sound according to vibration of the vibration generating module 500 may be output to an indoor space of the vehicle, and sound characteristics and/or sound pressure characteristics of the sound including a low-pitched band may be further improved. For example, the inclined surface 311s may be a guide surface or a sound guide surface, and the embodiments of the present disclosure are not limited thereto.

The vibration member 510 may be provided to be spaced apart from the opening portion 3100. The vibration member 510 may be provided in the inner space 313 to be spaced apart from the opening portion 3100. For example, the vibration member 510 may be disposed in the inner space 313, and may be provided between the first enclosure 311 and the second enclosure 312. For example, the vibration member 510 may be disposed in the inner space 313, and may be supported by the first enclosure 311 and the second enclosure 312.

The sound apparatus 30 according to the embodiment of the present disclosure may further include a coupling member 320. The coupling member 320 may include a first coupling member 321 and a second coupling member 322.

According to the embodiment of the present disclosure, the first enclosure 311 may be disposed or provided on the first surface (or rear surface) of the vibration member 510. The first enclosure 311 may be provided to support an edge portion of the first surface of the vibration member 510. For example, the first enclosure 311 may be provided to support edge portions of both sides of the first surface of the vibration member 510. The first enclosure 311 may be provided to cover the first surface of the vibration generating module 500. For example, the first enclosure 311 may be provided to surround the first surface of the vibration generating module 500.

The first coupling member 321 may be between the vibration member 510 and the first enclosure 311. The first coupling member 321 may be between an edge portion of the vibration member 510 and an edge portion of the first enclosure 311. For example, the first coupling member 321 may be between an edge portion of both sides of the vibration member 510 and an edge portion of both sides of the first enclosure 311. The edge portion of the first enclosure 311 may be connected to or coupled to the first surface of the vibration member 510 by the first coupling member 321. For example, the edge portion of the first enclosure 311 may be connected to or coupled to the edge portion of the first surface of the vibration member 510 by the first coupling member 321. For example, edge portions of both sides of the first enclosure 311 may be connected to or coupled to the edge portions of both sides of the first surface of the vibration member 510 by the first coupling member 321.

According to the embodiment of the present disclosure, the second enclosure 312 may be disposed or provided on the second surface (or rear surface) that is different from (or opposite to) the first surface of the vibration member 510. The second enclosure 312 may be provided to support an edge portion of the second surface of the vibration member 510. For example, the second enclosure 312 may be provided to support edge portions of both sides of the second surface of the vibration member 510. The second enclosure 312 may be provided to cover the second surface of the vibration generating module 500. For example, the second enclosure 312 may be provided to surround the second surface of the vibration generating module 500.

The second coupling member 322 may be between the vibration member 510 and the second enclosure 312. The second coupling member 322 may be between the edge portion of the vibration member 510 and an edge portion of the second enclosure 312. For example, the second coupling member 322 may be between an edge portion of both sides of the vibration member 510 and an edge portion of both sides of the second enclosure 312. The edge portion of the second enclosure 312 may be connected to or coupled to the second surface of the vibration member 510 by the second coupling member 322. For example, the edge portion of the second enclosure 312 may be connected to or coupled to the edge portion of the second surface of the vibration member 510 by the second coupling member 322. For example, edge portions of both sides of the second enclosure 312 may be connected to or coupled to the edge portions of both sides of the second surface of the vibration member 510 by the second coupling member 322.

According to the embodiment of the present disclosure, the coupling member 320 may be configured to minimize or block transfer of vibration of the vibration member 510 to the enclosure 310. The coupling member 320 may include material properties suitable for blocking vibration. For example, the coupling member 320 may include a material having elasticity. For example, the coupling member 320 may include a material having elasticity for vibration absorption (or shock absorption). The coupling member 320 according to the embodiment of the present disclosure may be made of a polyurethane material or a polyolefin material, but the embodiments of the present disclosure are not limited thereto. For example, the coupling member 320 may include at least one of an adhesive, a double-sided adhesive, a double-sided tape, a double-sided adhesive tape, a double-sided foam tape, a double-sided adhesive foam tape, a double-sided foam pad, a double-sided adhesive foam pad, or a double-sided cushion tape, but the embodiments of the present disclosure are not limited thereto.

The coupling member 320 according to another embodiment of the present disclosure may minimize or prevent the vibration of the vibration member 510 from being transferred to the enclosure 310, and may be configured to reduce reflection of sound waves generated and incident by the vibration of the vibration member 510.

Since the sound apparatus 30 according to the embodiment of the present disclosure includes the vibration generating module 500 having a bimorph structure, sound characteristics and/or sound pressure characteristics of sound including a low-pitched band may be improved. Since the sound apparatus 30 according to the embodiment of the present disclosure includes the enclosure 310 having the opening portion 3100, the low-pitched band may be expanded in accordance with the decrease of the air pressure of the inner space 313 of the enclosure 310, whereby sound characteristics and/or sound pressure characteristics of the low-pitched band may be improved.

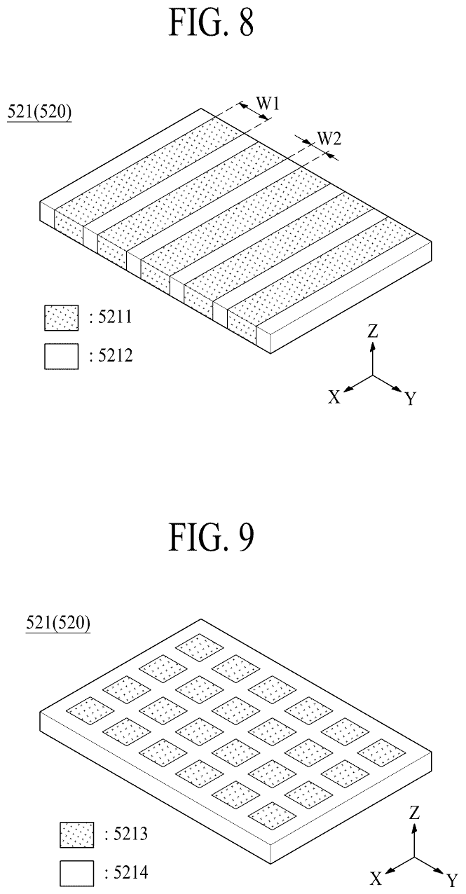

FIG. 8 is a view illustrating a vibration portion according to another embodiment of the present disclosure. FIG. 8 illustrates another embodiment of the vibration portion described above with reference to FIGS. 1 to 4.

Referring to FIGS. 2 and 8, the vibration portion 521 according to another embodiment of the present disclosure may include a plurality of first portions 5211 and a plurality of second portions 5212. For example, the plurality of first portions 5211 and the plurality of second portions 5212 may be alternately and repeatedly disposed along a first direction X (or a second direction Y).

Each of the plurality of first portions 5211 may include an inorganic material portion having a piezoelectric effect (or a piezoelectric characteristic). For example, each of the plurality of first portions 5211 may include at least one or more of a piezoelectric inorganic material and a piezoelectric organic material. For example, each of the plurality of first portions 5211 may be an inorganic portion, an inorganic material portion, a piezoelectric portion, a piezoelectric material portion, or an electroactive portion, but embodiments of the present disclosure are not limited thereto.

According to an embodiment of the present disclosure, each of the plurality of first portions 5211 may have a width W1 parallel to the second direction Y (or the first direction X) and may be extended along the first direction X (or the second direction Y). Each of the plurality of first portions 5211 may be configured in a material which is substantially a same as a vibration portion 521 described above with reference to FIGS. 1 to 4, and thus, repeated descriptions thereof are omitted.

Each of the plurality of second portions 5212 may be disposed between the plurality of first portions 5211. For example, each of the plurality of first portions 5211 may be disposed between two adjacent second portions 5212 of the plurality of second portions 5212. Each of the plurality of second portions 5212 may have a width parallel to the second direction Y (or the first direction X) and may be extended along the first direction X (or the second direction Y). The width W1 of first portions 5211 may be a same as or different from the width W2 of the second portions 5212. For example, the width W1 of first portions 5211 may be greater than the width W2 of the second portions 5212. For example, the first portion 5211 and the second portion 5212 may include a line shape or a stripe shape which has a same size or different sizes.

Each of the plurality of second portions 5212 may be configured to fill a gap between two adjacent first portions of the plurality of first portions 5211. Each of the plurality of second portions 5212 may be configured to fill a gap between two adjacent first portions of the plurality of first portions 5211, and thus, may be connected to or attached on lateral surfaces of the first portion 5211 adjacent thereto. According to an embodiment of the present disclosure, each of the plurality of first portions 5211 and the plurality of second portions 5212 may be disposed (or arranged) at a same plane (or a same layer) in parallel with each other. Therefore, the vibration portion 521 may be expanded to a desired size or length by a lateral coupling (or connection) of the first portions 5211 and the second portions 5212.

According to an embodiment of the present disclosure, each of the plurality of second portions 5212 may absorb an impact applied to the first portions 5211, and thus, may enhance the total durability of the first portions 5211 and provide flexibility to the vibration portion 521. Each of the plurality of second portions 5212 may include an organic material having a ductile characteristic. For example, each of the plurality of second portions 5212 may include one or more of an epoxy-based polymer, an acrylic-based polymer, and a silicone-based polymer, but embodiments of the present disclosure are not limited thereto. For example, each of the plurality of second portions 5212 may be an organic portion, an organic material portion, an adhesive portion, a stretch portion, a bending portion, a damping portion, or a ductile portion, but embodiments of the present disclosure are not limited thereto.

A first surface of each of the plurality of first portions 5211 and the plurality of second portions 5212 may be connected to the first electrode portion 523 in common. A second surface of each of the plurality of first portions 5211 and the plurality of second portions 5212 may be connected to the second electrode portion 525 in common. For example, one or both of the first electrode portion 523 and the second electrode portion 525 may be formed as a patterned electrode corresponding only to the plurality of first portions 5211, but the embodiments of the present disclosure are not limited thereto.

The plurality of first portions 5211 and the plurality of second portion 5212 may be disposed on (or connected to) the same plane, and thus, the vibration portion 521 according to another embodiment of the present disclosure may have a single thin film-type. Accordingly, the vibration generating module 500 or the vibration apparatus 520 including the vibration portion 521 according to another embodiment of the present disclosure may vibrate by the first portion 5211 having a vibration characteristic and may be bent in a curved shape by the second portion 5212 having flexibility.

FIG. 9 is a view illustrating a vibration portion according to another embodiment of the present disclosure. FIG. 9 illustrates another embodiment of the vibration portion described above with reference to FIGS. 1 to 4.

Referring to FIGS. 2 and 9, the vibration portion 521 according to another embodiment of the present disclosure may include a plurality of first portions 5213 and a second portion 5214 disposed between the plurality of first portions 5213.

Each of the plurality of first portions 5213 may be disposed to be spaced apart from one another along each of the first direction X and the second direction Y. For example, each of the plurality of first portions 5213 may have a hexahedral shape having a same size and may be disposed in a lattice shape, but embodiments of the present disclosure are not limited thereto. For example, each of the plurality of first portions 5213 may have a circular shape plate, an oval shape plate, or a polygonal shape plate, which has a same size as each other, but embodiments of the present disclosure are not limited thereto.

Each of the plurality of first portions 5213 may include a material which is be substantially a same as the first portion 5213 described above with reference to FIG. 8, and thus, repeated descriptions thereof are omitted.

The second portion 5214 may be disposed between the plurality of first portions 5213 along each of the first direction X and the second direction Y. The second portion 5214 may be configured to fill a gap between two adjacent first portions 5213 or to surround each of the plurality of first portions 5213, and thus, the second portion 5214 may be connected to or attached on the first portion 5213 adjacent thereto. The second portion 5214 may include a material which is be substantially a same as the second portion 5212 described above with reference to FIG. 8, and thus, repeated descriptions thereof are omitted.

A first surface of each of the plurality of first portions 15213 and the second portions 5214 may be connected to the first electrode portion 523 in common. A second surface of each of the plurality of first portions 5213 and the second portions 5214 may be connected to the second electrode portion 525 in common. According to another embodiment of the present disclosure, at least one of the first electrode portion 523 and the second electrode portion 525 may be formed in a pattern electrode shape corresponding only to the plurality of first portions 5213.

The plurality of first portions 5213 and the second portion 5214 may be disposed on (or connected to) the same plane, and thus, the vibration portion 521 according to another embodiment of the present disclosure may have a single thin film-type. Accordingly, the vibration generating module 500 or the vibration apparatus 520 including the vibration portion 521 according to another embodiment of the present disclosure may vibrate by the first portion 5213 having a vibration characteristic and may be bent in a curved shape by the second portion 5214 having flexibility.

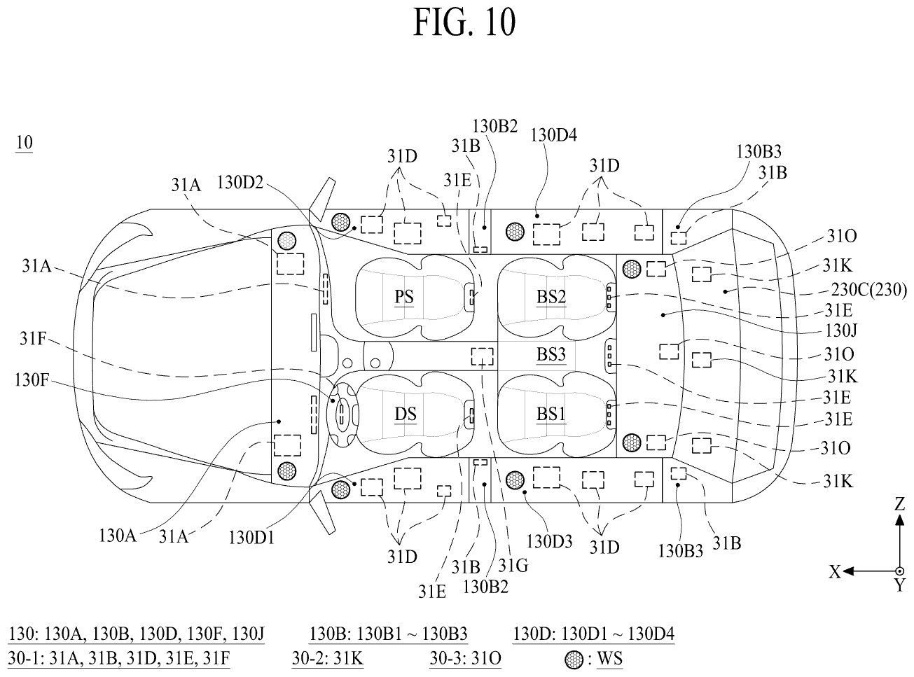

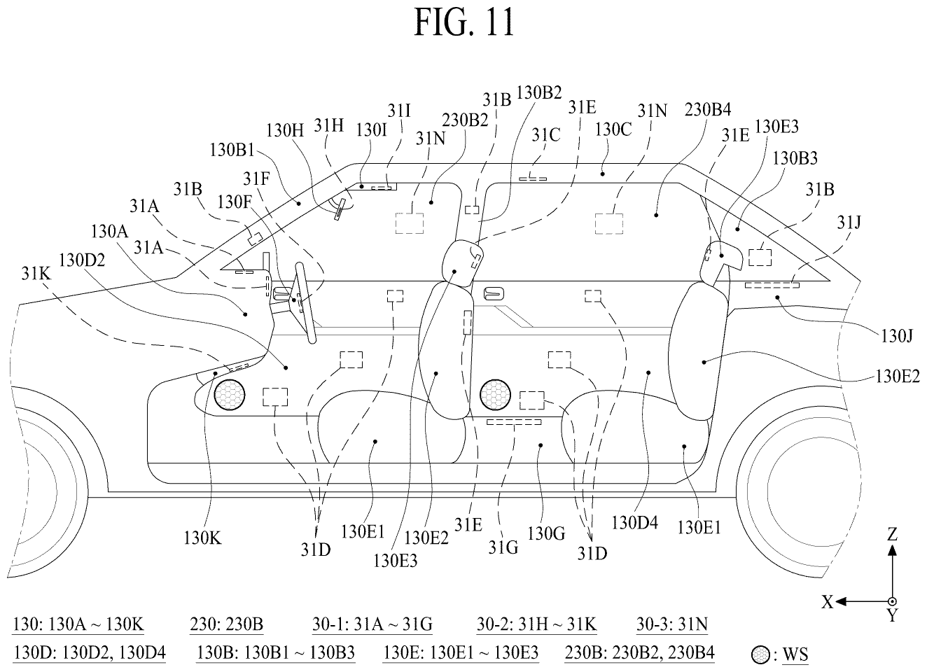

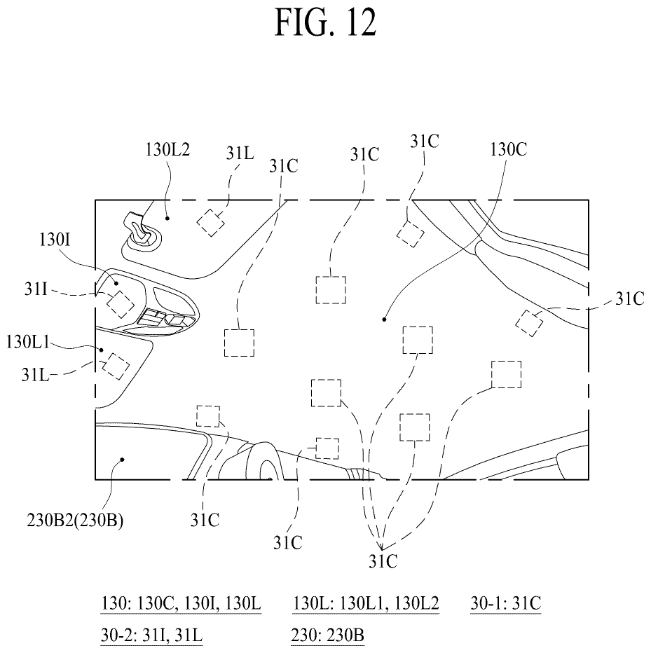

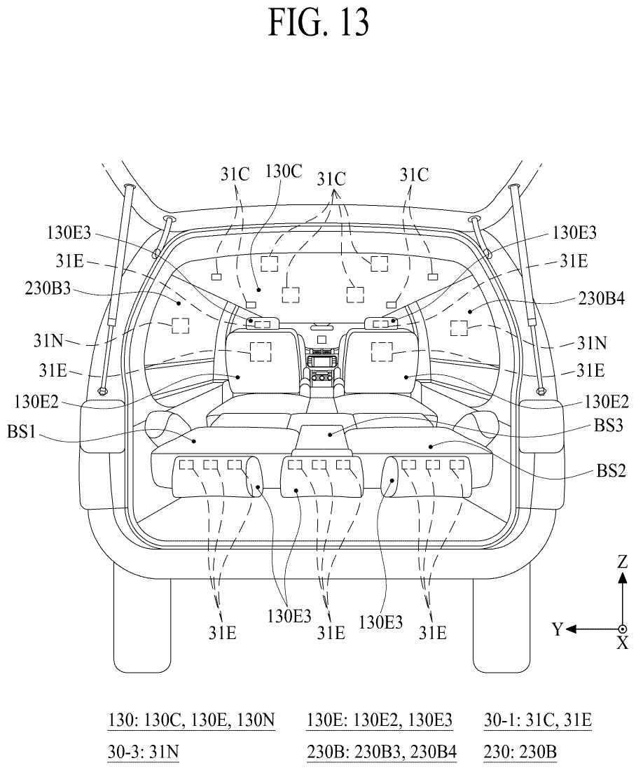

FIG. 10 is a view illustrating a vehicular apparatus according to the embodiment of the present disclosure. FIG. 11 is a view illustrating a vehicular apparatus according to the embodiment of the present disclosure. FIG. 12 is a view illustrating a sound generating apparatus disposed on a roof of a vehicular apparatus of FIGS. 10 and 11. FIG. 13 is a view illustrating a sound generating apparatus disposed on a roof and a seat of the vehicular apparatus of FIGS. 10 and 11.

Referring to FIGS. 10 to 13, a vehicular apparatus 10 according to an embodiment of the present disclosure may include a vehicle interior material 130 and a first sound generating apparatus 30-1. For example, the vehicle interior material 130 may output a sound based on a vibration of one or more first sound generating apparatuses 30-1. For example, the vehicle interior material 130 may be exposed at an indoor space.

The first sound generating apparatus 30-1 may include at least one or more sound generating modules 31A to 31G which are disposed at one or more of a dashboard 130A, a pillar interior material 130B, a roof interior material 130C, a door interior material 130D, a seat interior material 130E, a handle interior material 130F, and a floor interior material 130G. For example, the first sound generating apparatus 30-1 may include at least one or more of the first to seventh sound generating modules 31A to 31G, and thus, may output sounds of one or more channels.

The first sound generating module 31A according to an embodiment of the present disclosure may be disposed between the dashboard 130A and a dash panel and may vibrate the dashboard 130A to output a sound based on a vibration of the dashboard 130A. According to an embodiment of the present disclosure, the first sound generating module 31A may include a sound apparatus 30 described above with reference to FIGS. 5 to 7, and thus, repeated descriptions are omitted. For example, the first sound generating module 31A may be a dashboard speaker.

According to an embodiment of the present disclosure, at least one or more of the dash panel and the dashboard 130A may include a first region corresponding to a driver seat DS, a second region corresponding to a passenger seat PS, and a third region (or a middle region) between the first region and the second region. Herein, the driver seat DS and the passenger seat PS may also be referred to as “the front seats DS and PS.” At least one or more of the dash panel and the dashboard 130A may include a fourth region which is inclined to face the passenger seat PS. According to an embodiment of the present disclosure, the first sound generating module 31A may be disposed to vibrate at least one or more of the first to fourth regions of the dashboard 130A. For example, the first sound generating module 31A may be configured to output a sound of about 150 Hz to about 20 kHz. For example, the first sound generating module 31A configured to vibrate each of the first to fourth regions of the dashboard 130A may have a same sound output characteristic or different sound output characteristics.

The second sound generating module 31B according to an embodiment of the present disclosure may be disposed between the pillar interior material 130B and a pillar panel and may vibrate the pillar interior material 130B to output a sound based on a vibration of the pillar interior material 130B. According to an embodiment of the present disclosure, the second sound generating module 31B may include a sound apparatus 30 described above with reference to FIG. 7, and thus, repeated descriptions are omitted. For example, the second sound generating module 31B may be a pillar speaker or a tweeter speaker.

According to an embodiment of the present disclosure, the pillar panel may include a first pillar (or an A pillar) disposed at both sides of a front glass window, a second pillar (or a B pillar) disposed at both sides of a center of a vehicle body, and a third pillar (or a C pillar) disposed at both sides of a rear portion of the vehicle body. The pillar interior material 130B may include a first pillar interior material 130B1 covering the first pillar, a second pillar interior material 130B2 covering the second pillar, and a third pillar interior material 130B3 covering the third pillar. According to an embodiment of the present disclosure, the second sound generating module 31B may be disposed at at least one or more of a region between the first pillar and the first pillar interior material 130B1, a region between the second pillar and the second pillar interior material 130B2, and a region between the third pillar and the third pillar interior material 130B3, and thus, may vibrate at least one or more of the first to third pillar interior materials 130B1 to 130B3. For example, the second sound generating module 31B may be configured to output a sound at about 2 kHz to about 20 kHz, or may be configured to output a sound at about 150 Hz to about 20 kHz. For example, the second sound generating module 31B configured to vibrate at least one or more of the first to third pillar interior materials 130B1 to 130B3 may have a same sound output characteristic or different sound output characteristics.

Referring to FIGS. 10 to 13, the third sound generating module 31C according to an embodiment of the present disclosure may be disposed between the roof interior material 130C and a roof frame (or a roof panel) and may vibrate the roof interior material 130C to output a sound based on a vibration of the roof interior material 130C. For example, the third sound generating module 31C may directly vibrate the roof interior material 130C to output a sound based on a vibration of the roof interior material 130C. According to an embodiment of the present disclosure, the third sound generating module 31C may include a sound apparatus 30 described above with reference to FIG. 7, and thus, repeated descriptions are omitted. For example, the third sound generating module 31C may be a roof speaker.

Referring to FIGS. 10 to 12, the roof interior material 130C may include the first region corresponding to the driver seat DS, the second region corresponding to the passenger seat PS, a third region corresponding to a region between the driver seat DS and the passenger seat PS, a fourth region corresponding to a first rear seat BS1 behind the driver seat DS, a fifth region corresponding to a second rear seat BS2 behind the passenger seat PS, a sixth region corresponding to a third rear seat BS3 between the first rear seat BS1 and the second rear seat BS2, and a seventh region between the third region and the sixth region. For example, the third sound generating module 31C may be disposed to vibrate at least one or more among the first to seventh regions of the roof interior material 130C. For example, the third sound generating module 31C may be configured to output a sound of about 150 Hz to about 20 kHz. For example, the third sound generating module 31C configured to vibrate at least one or more of the first to seventh regions of the roof interior material 130C may have a same sound output characteristic or different sound output characteristics. For example, at least one or more of third sound generating modules 31C configured to vibrate each of the first to seventh regions of the roof interior material 130C may be configured to output a sound of about 2 kHz to about 20 kHz, and the other third sound generating modules 31C may be configured to output a sound of about 150 Hz to about 20 kHz.

Referring to FIGS. 10 and 11, the fourth sound generating module 31D according to an embodiment of the present disclosure may be disposed between the door frame and the door interior material 130D and may vibrate the door interior material 130D to output a sound based on a vibration of the door interior material 130D. According to an embodiment of the present disclosure, the fourth sound generating module 31D may include a sound apparatus 30 described above with reference to FIG. 7, and thus, repeated descriptions are omitted. For example, the fourth sound generating module 31D may be a door speaker.

According to an embodiment of the present disclosure, at least one or more of the door frame and the door interior material 130D may include an upper region, a middle region, and a lower region with respect to a height direction Z of the vehicular apparatus 10. For example, the fourth sound generating module 31D may be disposed at at least one or more of the upper region, the middle region, and the lower region between the door frame and the door interior material 130D, and thus, may vibrate at least one or more of the upper region, the middle region, and the lower region of the door interior material 130D.

According to an embodiment of the present disclosure, the upper region of the door interior material 130D may have a relatively small curvature radius. The fourth sound generating module 31D for vibrating the upper region of the door interior material 130D may include the sound apparatus having a flexible characteristic.

According to an embodiment of the present disclosure, the door frame may include a first door frame (or a left front door frame), a second door frame (or a right front door frame), a third door frame (or a left rear door frame), and a fourth door frame (or a right rear door frame). According to an embodiment of the present disclosure, the door interior material 130D may include a first door interior material (or a left front door interior material) 130D1 covering the first door frame, a second door interior material (or a right front door interior material) 130D2 covering the second door frame, a third door interior material (or a left rear door interior material) 130D3 covering the third door frame, and a fourth door interior material (or a right rear door interior material) 130D4 covering the fourth door frame. For example, the fourth sound generating module 31D may be disposed at at least one or more of an upper region, a middle region, and a lower region between each of the first to fourth door frames and the first to fourth door interior materials 130D1 to 130D4 and may vibrate at least one or more of the upper region, the middle region, and the lower region of each of the first to fourth door interior materials 130D1 to 130D4.

According to an embodiment of the present disclosure, the fourth sound generating module 31D configured to vibrate the upper region of each of the first to fourth door interior materials 130D1 to 130D4 may be configured to output a sound of about 2 kHz to about 20 kHz, or may be configured to output a sound of about 150 Hz to about 20 kHz.

According to an embodiment of the present disclosure, the fourth sound generating module 31D configured to vibrate the middle regions and the lower regions of at least one or more of the first to fourth door interior materials 130D1 to 130D4 may be configured to output a sound of about 150 Hz to about 20 kHz. The fourth sound generating module 31D configured to vibrate the middle region and the lower region of each of the first to fourth door interior materials 130D1 to 130D4 may be configured to output a sound of about 150 Hz to about 20 kHz. For example, the fourth sound generating module 31D configured to vibrate the middle regions and the lower regions of at least one or more of the first to fourth door interior materials 130D1 to 130D4 may be one or more of a woofer, a mid-woofer, and a sub-woofer. For example, the fourth sound generating module 31D configured to vibrate the middle region and the lower region of each of the first to fourth door interior materials 130D1 to 130D4 may be one or more of a woofer, a mid-woofer, and a sub-woofer.

Sounds, which are respectively output from the fourth sound generating module 31D disposed at the first door interior material 130D1 and the fourth sound generating module 31D disposed at the second door interior material 130D2, may be combined and output. For example, sounds, which are respectively output from at least one or more of the fourth sound generating module 31D disposed at the first door interior material 130D1 and the fourth sound generating module 31D disposed at the second door interior material 130D2, may be combined and output. In addition, sounds, which are respectively output from the fourth sound generating module 31D disposed at the third door interior material 130D3 and the fourth sound generating module 31D disposed at the fourth door interior material 130D4 may be combined and output.

According to an embodiment of the present disclosure, the upper region of each of the first to fourth door interior materials 130D1 to 130D4 may include a first upper region adjacent to the dashboard 130A, a second upper region adjacent to the rear seats BS1 to BS3, and a third upper region between the first upper region and the second upper region. For example, the fourth sound generating module 31D may be disposed at one or more of the first to third upper regions of each of the first to fourth door interior materials 130D1 to 130D4. For example, the fourth sound generating module 31D configured to vibrate the first upper regions of one or more of the first and second door interior materials 130D1 and 130D2 may be configured to output a sound of about 2 kHz to about 20 kHz, and the fourth sound generating module 31D configured to vibrate one or more among the second and third upper regions of each of the first and second door interior materials 130D1 and 130D2 may be configured to output a sound of about 2 kHz to about 20 kHz, or may be configured to output a sound of about 150 Hz to about 20 kHz. For example, the fourth sound generating module 31D configured to vibrate one or more among the second and third upper regions of at least one or more of the first and second door interior materials 130D1 and 130D2 may be configured to output a sound of about 2 kHz to about 20 kHz, or may be configured to output a sound of about 150 Hz to about 20 kHz.

Referring to FIGS. 10, 11, and 13, the fifth sound generating module 31E according to an embodiment of the present disclosure may be disposed between a seat frame and the seat interior material 130E and may vibrate the seat interior material 130E to output a sound based on a vibration of the seat interior material 130E. According to an embodiment of the present disclosure, the fifth sound generating module 31E may include a sound apparatus 30 described above with reference to FIGS. 5 to 7, and thus, repeated descriptions are omitted. For example, the fifth sound generating module 31E may be a sheet speaker or a headrest speaker.

According to an embodiment of the present disclosure, the seat frame may include a first seat frame (or a driver seat frame), a second seat frame (or a passenger seat frame), a third seat frame (or a first rear seat frame), a fourth seat frame (or a second rear seat frame), and a fifth seat frame (or a third rear seat frame). According to an embodiment of the present disclosure, the seat interior material 130E may include the first seat interior material surrounding the first seat frame, the second seat interior material surrounding the second seat frame, the third seat interior material surrounding the third seat frame, the fourth seat interior material surrounding the fourth seat frame, and the fifth seat interior material surrounding the fifth seat frame.

According to an embodiment of the present disclosure, at least one or more of the first to fifth seat frames may include a seat bottom frame, a seat back frame, and a headrest frame. The seat interior material 130E may include a seat bottom interior material 130E1 surrounding the seat bottom frame, a seat back interior material 130E2 surrounding the seat back frame, and a headrest interior material 130E3 surrounding the headrest frame. At least one or more of the seat bottom interior material 130E1, the seat back interior material 130E2, and the headrest interior material 130E3 may include an inner interior material and an outer interior material. For example, the inner interior material may include a foam layer. For example, the outer interior material may include a surface layer including a fiber or leather. For example, the outer interior material may further include a base layer including a plastic material which supports the surface layer.

According to an embodiment of the present disclosure, the fifth sound generating module 31E may be disposed at at least one or more of a region between the seat back frame and the seat back interior material 130E2 and a region between the headrest frame and the headrest interior material 130E3, and thus, may vibrate at least one or more of the outer interior material of the seat back interior material 130E2 and the outer interior material of the headrest interior material 130E3.

According to an embodiment of the present disclosure, the fifth sound generating module 31E disposed at at least one or more of the driver seat DS and the passenger seat PS may be disposed at at least one or more of the region between the seat back frame and the seat back interior material 130E2 and the region between the headrest frame and the headrest interior material 130E3.

According to an embodiment of the present disclosure, the fifth sound generating module 31E disposed at at least one or more of the first to third rear seats BS1 to BS3 may be disposed between the headrest frame and the headrest interior material 130E3. For example, at least one or more of the first to third rear seats BS1 to BS3 may include at least one or more fifth sound generating modules 31E disposed between the headrest frame and the headrest interior material 130E3.

According to an embodiment of the present disclosure, the fifth sound generating module 31E vibrating the seat back interior materials 130E2 of at least one or more of the driver seat DS and the passenger seat PS may be configured to output a sound of about 150 Hz to about 20 kHz. According to an embodiment of the present disclosure, the fifth sound generating module 31E vibrating the headrest interior materials 130E3 of at least one or more of the driver seat DS, the passenger seat PS, and the first to third rear seats BS1 to BS3 may be configured to output a sound of about 2 kHz to about 20 kHz, or may be configured to output a sound of about 150 Hz to about 20 KHz.

Referring to FIGS. 10 and 11, the sixth sound generating module 31F according to an embodiment of the present disclosure may be disposed between a handle frame and the handle interior material 130F and may vibrate the handle interior material 130F to output a sound based on a vibration of the handle interior material 130F. According to an embodiment of the present disclosure, the sixth sound generating module 31F may include a sound apparatus 30 described above with reference to FIGS. 7, and thus, repeated descriptions are omitted. For example, the sixth sound generating module 31F may be a handle speaker or a steering speaker.

According to an embodiment of the present disclosure, the sixth sound generating module 31F may directly vibrate the handle interior material 130F to provide the driver with the sound based on the vibration of the handle interior material 130F. A sound output by the sixth sound generating module 31F may be a sound which is a same as or different from a sound output from each of the first to fifth sound generating modules 31A to 31E. As an embodiment of the present disclosure, the sixth sound generating module 31F may output a sound which is to be provided to only the driver. As another embodiment of the present disclosure, the sound output by the sixth sound generating module 31F and a sound output by each of the first to fifth sound generating modules 31A to 31E may be combined and output.

Referring to FIGS. 10 and 11, the seventh sound generating module 31G may be disposed between the floor panel and the floor interior material 130G and may indirectly or directly vibrate the floor interior material 130G to output a sound based on a vibration of the floor interior material 130G.

The seventh sound generating module 31G may be disposed between the floor panel and the floor interior material 130G disposed between the front seats DS and PS and the third rear seat BS3. For example, the seventh sound generating module 31G may include a sound apparatus 30 described above with reference to FIG. 7, and thus, repeated descriptions are omitted. For example, the seventh sound generating module 31G may be configured to output a sound of about 150 Hz to about 20 kHz. For example, the seventh sound generating module 31G may be a floor speaker, a bottom speaker, or an under speaker.

Referring to FIGS. 10 to 12, the vehicular apparatus or the vehicle 10 according to an embodiment of the present disclosure may further include a second sound generating apparatus 30-2 which is disposed at the vehicle interior material 130 exposed to an indoor space. For example, the vehicular apparatus or the vehicle 10 according to an embodiment of the present disclosure may include only the second sound generating apparatus 30-2 instead of the first sound generating apparatus 30-1, or may include all of the first sound generating apparatus 30-1 and the second sound generating apparatus 30-2.

According to an embodiment of the present disclosure, the vehicle interior material 130 may further include a rear view mirror 130H, an overhead console 130I, a rear package interior material 130J, a glove box 130K, and a sun visor 130L, or the like.

The second sound generating apparatus 30-2 may include at least one or more sound generating modules 31H to 31L which are disposed at at least one of the rear view mirror 130H, the overhead console 130I, the rear package interior material 130J, the glove box 130K, and the sun visor 130L. For example, the second sound generating apparatus 30-2 may include at least one or more of eighth to twelfth sound generating modules 31H to 31L, and thus, may output sounds of one or more channels.

Referring to FIGS. 10 to 12, the eighth sound generating module 31H may be disposed at the rear view mirror 130H and may indirectly or directly vibrate the rear view mirror 130H to output a sound based on a vibration of the rear view mirror 130H.

The eighth sound generating module 31H may be disposed between a mirror housing connected to a vehicle body structure and the rear view mirror 130H supported by the mirror housing. According to an embodiment of the present disclosure, the eighth sound generating module 31H may include a sound apparatus 30 described above with reference to FIG. 7, and thus, repeated descriptions are omitted. For example, the eighth sound generating module 31H may be configured to output a sound of about 150 Hz to about 20 kHz. For example, the eighth sound generating module 31H may be a mirror speaker.

Referring to FIGS. 12 and 13, the ninth sound generating module 31I may be disposed at the overhead console 130I and may indirectly or directly vibrate a console cover of the overhead console 130I to output a sound based on a vibration of an interior material (or the console cover) of the overhead console 130I.

According to an embodiment of the present disclosure, the overhead console 130I may include a console box buried (or embedded) into the roof panel, a lighting device disposed at the console box, and the console cover covering the lighting device and the console box.

The ninth sound generating module 31I may be disposed between the console cover and the console box of the overhead console 130I and may vibrate the console cover. According to an embodiment of the present disclosure, the ninth sound generating module 31I may include a sound apparatus 30 described above with reference to FIG. 7, and thus, repeated descriptions are omitted. For example, the ninth sound generating module 31I may be configured to output a sound of about 150 Hz to about 20 kHz. For example, the ninth sound generating module 31I may be a console speaker or a lighting speaker.

According to an embodiment of the present disclosure, the vehicular apparatus or the vehicle 10 may further include a center lighting box disposed at a center region of the roof interior material 130C, a center lighting device disposed at the center lighting box, and a center lighting cover covering the center lighting device. In this case, the ninth sound generating module 31I may be further disposed between a center lighting cover and a center lighting box of the center lighting device and may additionally vibrate the center lighting cover.

Referring to FIGS. 10 and 11, the tenth sound generating module 31J may be disposed at the rear package interior material 130J and may indirectly or directly vibrate the rear package interior material 130J to output a sound based on a vibration of the rear package interior material 130J.

The rear package interior material 130J may be disposed behind the first to third rear seats BS1 to BS3. For example, a portion of the rear package interior material 130J may be disposed under a rear glass window 230C.

The tenth sound generating module 31J may be disposed at a rear surface of the rear package interior material 130J and may indirectly or directly vibrate the rear package interior material 130J. According to an embodiment of the present disclosure, the tenth sound generating module 31J may include a sound apparatus 30 described above with reference to FIG. 7, and thus, repeated descriptions are omitted. For example, the tenth sound generating module 31J may be a rear speaker.

According to an embodiment of the present disclosure, the rear package interior material 130J may include a first region corresponding to a rear portion of the first rear seat BS1, a second region corresponding to a rear portion of the second rear seat BS2, and a third region corresponding to a rear portion of the third passenger seat BS3. According to an embodiment of the present disclosure, the tenth sound generating module 31J may be disposed to vibrate at least one or more of the first to third regions of the rear package interior material 130J. For example, the tenth sound generating module 31J may be configured to output a sound of about 150 Hz to about 20 kHz. For example, the tenth sound generating module 31J configured to vibrate at least one or more of the first to third regions of the rear package interior material 130J may have a same sound output characteristic or different sound output characteristics.

Referring to FIGS. 10 and 11, the eleventh sound generating module 31K may be disposed at a glove box 130K and may indirectly or directly vibrate the glove box 130K to output a sound based on a vibration of the glove box 130K.

The glove box 130K may be disposed at a dashboard 130A corresponding to a front portion of the passenger seat PS.

The eleventh sound generating module 31K may be disposed at an inner surface of the glove box 130K and may vibrate the glove box 130K. According to an embodiment of the present disclosure, the eleventh sound generating module 31K may include a sound apparatus 30 described above with reference to FIG. 7, and thus, repeated descriptions are omitted. For example, the eleventh sound generating module 31K may be configured to output a sound of about 150 Hz to about 20 kHz, or may be one or more of a woofer, a mid-woofer, and a sub-woofer. For example, the eleventh sound generating module 31K may be a glove box speaker.

Referring to FIG. 12, the twelfth sound generating module 31L may be disposed at the sun visor 130L and may vibrate the sun visor 130L to output a sound based on a vibration of the sun visor 130L. For example, the twelfth sound generating module 31L may directly vibrate the sun visor 130L to output the sound based on the vibration of the sun visor 130L.

The sun visor 130L may include a first sun visor 130L1 corresponding to the driver seat DS and a second sun visor 130L2 corresponding to the passenger seat PS.

The twelfth sound generating module 31L may be disposed at at least one or more of the first sun visor 130L1 and the second sun visor 130L2 and may vibrate at least one or more of the first sun visor 130L1 and the second sun visor 130L2. For example, the twelfth sound generating module 31L may directly vibrate at least one or more of the first sun visor 130L1 and the second sun visor 130L2. According to an embodiment of the present disclosure, the twelfth sound generating module 31L may include a sound apparatus 30 described above with reference to FIGS. 5 to 7, and thus, repeated descriptions are omitted. For example, the twelfth sound generating module 31L may be configured to output a sound of about 150 Hz to about 20 kHz. For example, the twelfth sound generating module 31L may be a sun visor speaker.

According to an embodiment of the present disclosure, at least one or more of the first sun visor 130L1 and the second sun visor 130L2 may further include a sun visor mirror. In this case, the twelfth sound generating module 31L may be configured to vibrate a sun visor mirror of at least one or more of the first sun visor 130L1 and the second sun visor 130L2. The twelfth sound generating module 31L may directly vibrate the sun visor mirror of at least one or more of the first sun visor 130L1 and the second sun visor 130L2. The twelfth sound generating module 31L vibrating the sun visor mirror may include a sound apparatus 30 described above with reference to FIG. 7, and thus, repeated descriptions are omitted.

Referring to FIGS. 10 to 12, the vehicular apparatus or the vehicle 10 according to an embodiment of the present disclosure may further include a third sound generating apparatus 30-3 disposed at a vehicle glass window 230. For example, the vehicular apparatus or the vehicle 10 according to an embodiment of the present disclosure may include the third sound generating apparatus 30-3 instead of at least one or more of the first and second sound generating apparatuses 30-1 and 30-2, or may include all of the first to third sound generating apparatuses 30-1 to 30-3.

The third sound generating apparatus 30-3 may include at least one or more sound generating modules 31N to 31O disposed at the vehicle glass window 230. For example, the third sound generating apparatus 30-3 may include at least one or more of thirteenth and fourteenth sound generating modules 31N and 31O, and thus, may output sounds of one or more channels. For example, the third sound generating apparatus 30-3 may be a transparent sound generating apparatus.

The vehicle glass window 230 of the vehicular apparatus or the vehicle 10 may include at least one or more of a front glass window and a side glass window. The vehicle glass window 230 of the vehicular apparatus may further include at least one or more of a rear glass window and a roof glass window.

The vehicle glass window 230 according to an embodiment of the present disclosure may be configured to be wholly transparent. The vehicle glass window 230 according to another embodiment of the present disclosure may include a transparent portion and a semitransparent portion surrounding the transparent portion. The vehicle glass window 230 according to another embodiment of the present disclosure may include a transparent portion and an opaque portion surrounding the transparent portion.

The vibration generating module 500 described above with reference to FIGS. 1 to 4 may be configured to be transparent or semitransparent. For example, when the vehicle glass window 230 is wholly transparent, the vibration generating module 500 may be configured to be transparent and may be disposed at a middle region or a peripheral region of the vehicle glass window 230. When the vehicle glass window 230 includes the semitransparent portion or the opaque portion, the vibration generating module 500 may be configured to be semitransparent or opaque and may be disposed at the semitransparent portion or the opaque portion of the vehicle glass window 230. For example, the vibration generating module 500 may be a transparent sound generating module.

Referring to FIGS. 1 to 7 in conjunction with FIG. 10, the vibration generating module 500 may be disposed at one surface (or an indoor surface) of the vehicle glass window 230 exposed to inside or an indoor space IS of the vehicular apparatus or the vehicle 10. For example, a sound apparatus 30 for vehicles may include at least one or more the vibration generating module 500 disposed at the vehicle glass window 230, or a plurality of the vibration generating module 500 disposed at the vehicle glass window 230. As an embodiment of the present disclosure, the vibration generating module 500 may be disposed at at least one or more of the front glass window and the side glass window and may be further disposed at at least one or more of the rear glass window and the roof glass window.

The at least one or more of the thirteenth and fourteenth sound generating modules 31N and 310 may include the transparent or semitransparent vibration generating module 500. For example, when the at least one or more of the thirteenth and fourteenth sound generating modules 31N and 310 includes the vibration generating module 500, the at least one or more of the thirteenth and fourteenth sound generating modules 31N and 310 may vibrate the vehicle glass window 230 to output a sound based on a vibration of the vehicle glass window 230. For example, the at least one or more of the thirteenth and fourteenth sound generating modules 31N and 310 may directly vibrate the vehicle glass window 230 to output a sound based on a vibration of the vehicle glass window 230.

According to an embodiment of the present disclosure, the vehicle glass window 230 may include the front glass window, the side glass window 230B, and the rear glass window. According to an embodiment of the present disclosure, the vehicle glass window 230 may further include the roof glass window 230D. For example, when the vehicular apparatus or the vehicle 10 includes the roof glass window 230D, a portion of a region of the roof frame and the roof interior material 130C may be replaced with the roof glass window 230D. For example, when the vehicular apparatus or the vehicle 10 includes the roof glass window 230D, the third sound generating module 31C may be configured to vibrate a periphery portion of the roof interior material 130C surrounding the roof glass window 230D.

Referring to FIGS. 11 to 13, the thirteenth sound generating module 31N according to an embodiment of the present disclosure may be disposed at the side glass window 230B and may be configured to output a sound by vibrating itself (or self-vibration thereof), or may be configured to indirectly or directly vibrate the side glass window 230B to output a sound based on a vibration of the side glass window 230B. For example, the thirteenth sound generating module 31N may directly vibrate the side glass window 230B to output a sound based on the vibration of the side glass window 230B.

According to an embodiment of the present disclosure, the side glass window 230B may include a first side glass window (or a right front window) 230B2, a second side glass window (or a left rear window) 230B3, a third side glass window (or a right rear window) 230B4, and a fourth side glass window (or a left front window).

According to an embodiment of the present disclosure, the thirteenth sound generating module 31N may be disposed at at least one or more of the first to third side glass windows 230B2 to 230B4. For example, at least one or more of the first to third side glass windows 230B2 to 230B4 may include at least one or more thirteenth sound generating module 31N.

The thirteenth sound generating module 31N may be disposed at at least one or more of the first to third side glass windows 230B2 to 230B4 and may output a sound by vibrating itself (or self-vibration thereof), or may vibrate a corresponding side glass windows 230B2 to 230B4 to output a sound. For example, the thirteenth sound generating module 31N may directly vibrate the side glass windows 230B2 to 230B4 to output the sound. For example, the thirteenth sound generating module 31N may be configured to output the sound of 150 Hz to 20 kHz. For example, the thirteenth sound generating module 31N disposed at at least one or more of the first to third side glass windows 230B2 to 230B4 may have a same sound output characteristic or different sound output characteristics. For example, the thirteenth sound generating module 31N disposed at at least one or more of the first to third side glass windows 230B2 to 230B4 may be configured to output the sound of 150 Hz to 20 kHz. For example, the thirteenth sound generating module 31N may be a side window speaker.

Referring to FIG. 11, the fourteenth sound generating module 31O according to an embodiment of the present disclosure may be disposed at the rear glass window 230C and may output a sound by vibrating itself (or self-vibration thereof), or may vibrate the rear glass window 230C to output a sound based on a vibration of the rear glass window 230C. For example, the fourteenth sound generating module 31O may directly vibrate the rear glass window 230C to output the sound based on the vibration of the rear glass window 230C.

According to an embodiment of the present disclosure, the rear glass window 230C may include a first region corresponding to a rear portion of the first rear seat BS1, a second region corresponding to a rear portion of the second rear seat BS2, and a third region corresponding to a rear portion of the third rear seat BS3. According to an embodiment of the present disclosure, the fourteenth sound generating module 31O disposed at at least one of the first to third regions of the rear glass window 230C and may vibrate at least one of the first to third regions of the rear glass window 230C to output sound. For example, the fourteenth sound generating module 31O disposed at each of the first to third regions of the rear glass window 230C may have a same sound output characteristic or different sound output characteristics. For example, the fourteenth sound generating module 31O disposed at at least one or more of the first and second regions of the rear glass window 230C may be configured to output a sound of about 150 Hz to about 20 kHz, or may be one or more of a woofer, a mid-woofer, and a sub-woofer. For example, the fourteenth sound generating module 31O may be a rear window speaker.

Referring to FIGS. 10 and 11, the vehicular apparatus or the vehicle 10 according to an embodiment of the present disclosure may further include a woofer speaker WS which is disposed at at least one or more of a dashboard 130A, a door frame, and a rear package interior material 130J.

The woofer speaker WS according to an embodiment of the present disclosure may include at least one or more of a woofer, a mid-woofer, and a sub-woofer. For example, the woofer speaker WS may be a speaker which outputs a sound of about 60 Hz to about 150 Hz. Therefore, the woofer speaker WS may output a sound of about 60 Hz to about 150 Hz, and thus, may enhance a low-pitched sound band characteristic of a sound which is output to an indoor space.

According to an embodiment of the present disclosure, the woofer speaker WS may be disposed at at least one or more of first and second regions of the dashboard 130A. According to an embodiment of the present disclosure, the woofer speaker WS may be disposed at each of first to fourth door frames of the door frame and may be exposed at a lower region of each of the first to fourth door interior materials 130D1 to 130D4 of the door interior material 130D. For example, the woofer speaker WS may be disposed at at least one or more of the first to fourth door frames of the door frame and may be exposed at the lower regions of at least one or more of the first to fourth door interior materials 130D1 to 130D4 of the door interior material 130D. For example, the fourth sound generating module 31D disposed at the lower region of at least one or more of the first to fourth door interior materials 130D1 to 130D4 may be replaced by the woofer speaker WS.

The vehicular apparatus according to an embodiment of the present disclosure may further include a garnish member and one or more sound generation apparatus 30 arranged in the vehicle interior material 130. For example, one or more sound generation apparatus 30 may be placed on the garnish member and the vehicle interior material 130 to output sound. For example, at least one of the garnish member and the vehicle interior material 130 may output sound according to the vibration of one or more sound generation apparatus (or vibration apparatus).

The garnish member may be configured to cover a portion of the door interior material 130D exposed to the indoor space, but embodiments of the present disclosure are not limited thereto. For example, the garnish member may be configured to cover a portion of one or more of the dashboard 130A, the pillar interior material 130B, and the roof interior material 130C, which are exposed to the indoor space.

The garnish member according to an embodiment of the present disclosure may include a metal material or a nonmetal material (or a composite nonmetal material) having a material characteristic suitable for generating a sound based on a vibration. For example, a metal material of the garnish member may include any one or more materials of stainless steel, aluminum (Al), an Al alloy, a magnesium (Mg), a Mg alloy, and a magnesium-lithium (Mg—Li) alloy, but embodiments of the present disclosure are not limited thereto. The nonmetal material (or the composite nonmetal material) of the garnish member may include one or more of wood, plastic, glass, cloth, fiber, rubber, paper, carbon, and leather, but embodiments of the present disclosure are not limited thereto. For example, the garnish member may include a metal material having a material characteristic suitable for generating a sound of a high-pitched sound band, but embodiments of the present disclosure are not limited thereto. For example, the high-pitched sound band may have a frequency of 1 kHz or more or 3 kHz or more, but embodiments of the present disclosure are not limited thereto.

One or more sound generating apparatus 30 may be placed between the garnish member and the vehicle interior material 130. For example, the one or more sound generation apparatus 30 may be garnish speakers, etc., but the embodiments of the present disclosure are not limited thereto.

One or more sound generation apparatus 30 according to the embodiments of the present disclosure may include the vibration generating module 500 described with reference to FIGS. 1 to 4. The one or more sound generation apparatus 30 may be placed on the interior material or the vehicle interior material 130, and the garnish member, and may be connected or coupled to the garnish member.

One or more sound generation apparatus 30 according to the embodiments of the present disclosure may be configured to indirectly or directly vibrate the garnish member to output sound into the interior space of the vehicular apparatus. For example, the one or more sound generation apparatus 30 may be configured to output high-pitched sound, but the embodiments of the present disclosure are not limited thereto.

The vehicular apparatus or the vehicle 10 according to an embodiment of the present disclosure may output a sound to the indoor space through at least one or more of the first sound generating apparatus 30-1 disposed at the vehicle interior material 130, the second sound generating apparatus 30-2 disposed at the vehicle interior material 130 exposed at the indoor space, the third sound generating apparatus 30-3 disposed at the vehicle glass window 230, and the fourth sound generating apparatus 30-4 disposed at the garnish member, and thus, may output the sound by a vehicle interior material 130 as a vibration plate or a sound vibration plate, thereby outputting a multi-channel surround stereo sound.

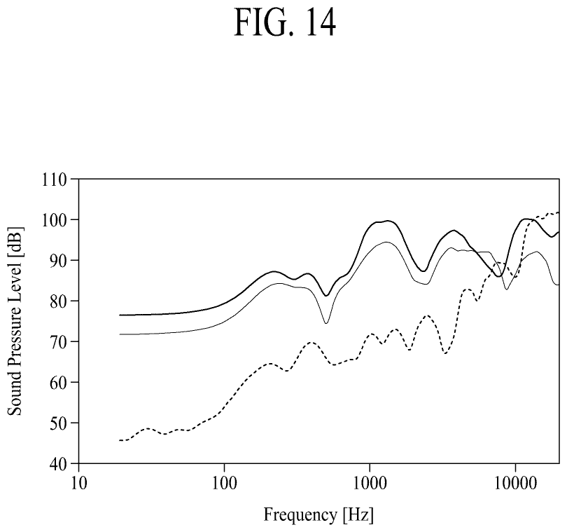

FIG. 14 is a view illustrating sound output characteristics of a sound apparatus according to embodiments and experimental examples of the present disclosure.

In order to evaluate sound pressure characteristics for each frequency of the vibration generating module according to the embodiment of the present disclosure, the inventors of the present disclosure prepared samples according to Experimental Example 1, Experimental Example 2, and Embodiment. In FIG. 14, a horizontal axis represents a frequency (hertz (Hz)), and a vertical axis represents a sound pressure level (SPL; decibel (dB)). In FIG. 14, a thin solid line, a dotted line and a thick solid line represent sound pressure characteristics for each frequency of Experimental Example 1, Experimental Example 2, and Embodiment, respectively. Sound output characteristics were measured in an anechoic room, power was measured at 5 Vrms, and a distance between each sample and a measurement microphone was measured at a condition of 30 cm, but the measurement method does not limit the content of the present disclosure.

In Experimental Example 1, a sample was configured to constitute a first vibration apparatus having a first signal supply member on a first surface of a vibration member, and a second vibration apparatus having a second signal supply member on a second surface of the vibration member. For example, Experimental Example 1 has a structure in which a signal supply member is provided in each of the first vibration apparatus and the second vibration apparatus. In Experimental Example 1, the vibration apparatus includes two signal supply members, wherein the first signal supply member is directly connected to an electrode portion of the first vibration apparatus, and the second signal supply member is directly connected to the electrode portion of the second vibration apparatus. In Experimental Example 1, the same signal (e.g., + voltage) is applied to the first electrode portion of the first vibration apparatus and the second electrode portion of the second vibration apparatus, and the same signal (e.g., − voltage) is applied to the second electrode portion of the first vibration apparatus and the first electrode portion of the second vibration apparatus. For example, the vibration portion of the vibration apparatus may vibrate by alternately repeating contraction and expansion by a reverse piezoelectric effect according to a vibration driving signal applied to the first and second electrode portions. For example, in Experimental Example 1, the vibration portion of the first vibration apparatus may expand and the vibration portion of the second vibration apparatus may contract. Each vibration portion may vibrate by vibration d₃₃ in a vertical direction and vibration d₃₁ in a plane direction (or horizontal direction) by repeating such expansion and contraction.

In Experimental Example 2, a sample may be configured in the same manner as the embodiment of the present disclosure described with reference to FIGS. 1 to 4. However, in Experimental Example 2, a third hole and fourth hole, which are configured in the vibration portion, overlap each other, and the same signal (e.g., + voltage) is applied to the first electrode portion of the first vibration apparatus and the first electrode portion of the second vibration apparatus, and the same signal (e.g., − voltage) is applied to the second electrode portion of the first vibration apparatus and the second electrode portion of the second vibration apparatus. For example, in Experimental Example 2, the vibration portion of the first vibration apparatus may expand, and the vibration portion of the second vibration apparatus may expand. Accordingly, since the vibration portion of the first vibration apparatus and the vibration portion of the second vibration apparatus expand simultaneously or contract simultaneously, the vibration d₃₃ in the vertical direction and the vibration d₃₁ in the plane direction (or horizontal direction) may be offset to generate sound pressure attenuation.

In Embodiment, a sample may be configured in the same manner as the embodiment of the present disclosure described with reference to FIGS. 1 to 4. In Embodiment, the same signal (e.g., + voltage) is applied to the first electrode portion of the first vibration apparatus and the second electrode portion of the second vibration apparatus, and the same signal (e.g., − voltage) is applied to the second electrode portion of the first vibration apparatus and the first electrode portion of the second vibration apparatus. For example, in Embodiment, the vibration layer of the first vibration apparatus may expand and the vibration layer of the second vibration apparatus may contract. Each vibration layer may vibrate by vibration d₃₃ in the vertical direction and vibration d₃₁ in the plane direction (or horizontal direction) by repeating such expansion and contraction.

Table 1 shows an average sound pressure according to frequencies of Experimental Example 1, Experimental Example 2, and Embodiment.

TABLE 1

| | Average sound pressure (dB) | | |
|---|---|---|---|
| | Experimental | Experimental | |
| Frequency (Hz) | Example 1 | Example 2 | Embodiment |
| 300 Hz-8 kHz | 87.81 | 72.60 | 91.19 |
| 150 Hz-20 kHz | 87.17 | 75.57 | 91.51 |
| ASPL(300 Hz-8 kHz) | N/A | −15.21 | 3.38 |
| ASPL (150 Hz-20 kHz) | N/A | −11.61 | 4.34 |

Referring to FIG. 14 and Table 1, the average sound pressures of Experimental Example 1, Experimental Example 2, and Embodiment were measured as 87.81 dB, 72.60 dB and 91.19 dB at 300 Hz to 8 kHz, respectively, and were measured as 87.17 dB, 75.57 dB and 91.51 dB at 150 Hz to 20 kHz, respectively.

In comparison with Experimental Example 1, the average sound pressure of Experimental Example 2 was reduced by 15.21 dB at 300 Hz-8 kHz and reduced by 11.61 dB at 150 Hz-20 kHz. For example, in Experimental Example 2, since the vibration portion of the first vibration apparatus and the vibration portion of the second vibration apparatus are simultaneously expanded or contracted, the vibration d₃₃ in the vertical direction and the vibration d₃₁ in the plane direction (or horizontal direction) may be offset. Accordingly, since the vibrations in the first vibration apparatus and the second vibration apparatus are offset, it was confirmed that the average sound pressure of Experimental Example 2 was reduced compared to Experimental Example 1.

In comparison with Experimental Example 1, the average sound pressure of Embodiment was increased by 3.38 dB at 300 Hz to 8 kHz and increased by 4.34 dB at 150 Hz to 20 kHz. For example, in Embodiment, it was confirmed that each vibration portion may vibrate by the vibration d₃₃ in the vertical direction and the vibration d₃₁ in the plane direction (or horizontal direction) by alternately repeating expansion and contraction. In comparison with Experimental Examples 1 and 2, it was confirmed that sound pressure characteristics of Embodiment were improved.

Accordingly, it was confirmed that the vibration generating module according to the embodiment of the present disclosure includes the connection portion in the vibration member, and connects the vibration apparatus with one signal supply member, thereby simplifying the structure and improving sound characteristics and/or sound pressure characteristics.

A vibration generating module, sound apparatus comprising the same, and vehicular apparatus comprising same according to example embodiments of the present disclosure are described below.

A vibration generating module according to one or more embodiments of the present disclosure may comprise a vibration member, a pad portion on a first surface of the vibration member, a first vibration apparatus on the first surface of the vibration member and connected to the pad portion, and a second vibration apparatus on a second surface opposite to the first surface of the vibration member and connected to the pad portion.

According to one or more embodiments of the present disclosure, the vibration generating module may further comprise a signal supply member electrically connected to the pad portion on the first surface of the vibration member.

According to one or more embodiments of the present disclosure, the vibration generating module may further comprise a first connection member electrically connected to the pad portion and the first vibration apparatus, and a second connection member electrically connected to the pad portion and the second vibration apparatus. The pad portion includes a connection portion electrically connected to the first connection member and the second connection member.

According to one or more embodiments of the present disclosure, the connection portion may be configured to pass through the first surface and the second surface of the vibration member.

According to one or more embodiments of the present disclosure, the connection portion may include a hole passing through the first surface and the second surface of the vibration member, and a conductive material filled in the hole.

According to one or more embodiments of the present disclosure, each of the first vibration apparatus and the second vibration apparatus may include a vibration portion containing a piezoelectric material, a first electrode portion on a first surface of the vibration portion, a second electrode portion on a second surface opposite to the first surface of the vibration portion, and an auxiliary electrode portion on the first surface of the vibration portion, the auxiliary electrode portion being electrically separated from the first electrode portion and electrically connected to the second electrode portion.

According to one or more embodiments of the present disclosure, the auxiliary electrode portion of the first vibration apparatus overlaps or does not overlap the auxiliary electrode portion of the second vibration apparatus with the vibration member interposed therebetween.

According to one or more embodiments of the present disclosure, the vibration generating module may further comprise a first connection member electrically connected to each of the auxiliary electrode portion and the first electrode portion of the first vibration apparatus and the pad portion, and a second connection member electrically connected to each of the auxiliary electrode portion and the first electrode portion of the second vibration apparatus and the pad portion.

According to one or more embodiments of the present disclosure, the pad portion may further include a connection portion electrically connected to the first connection member and the second connection member.

According to one or more embodiments of the present disclosure, the connection portion may include a first connection portion and a second connection portion, which are configured to pass through the first and second surfaces of the vibration member and parallel with each other, any one of the first connection member and the second connection member is electrically connected to the first connection portion, and the other one of the first connection member and the second connection member is electrically connected to the second connection portion.

According to one or more embodiments of the present disclosure, the first connection portion may include a first hole passing through the first surface and the second surface of the vibration member, and a conductive material filled in the first hole, and the second connection portion may include a second hole passing through the first surface and the second surface of the vibration member and parallel with the first hole, and a conductive material filled in the second hole.

According to one or more embodiments of the present disclosure, the connection portion may include a first connection portion and a second connection portion, which are configured to pass through the first surface and the second surface of the vibration member and parallel with each other. The first connecting member may include a first conductive member electrically connected to the auxiliary electrode portion of the first vibration apparatus and the first connection portion, and a second conductive member electrically connected to the first electrode portion of the first vibration apparatus and the second connection portion, and the second connecting member may include a first conductive member electrically connected to the first electrode portion of the second vibration apparatus and the first connection portion, and a second conductive member electrically connected to the auxiliary electrode portion of the second vibration apparatus and the second connection portion.

According to one or more embodiments of the present disclosure, the first conductive member and the second conductive member may include a conductive tape or lead.

According to one or more embodiments of the present disclosure, the vibration generating module may further comprise a first cover member configured on a portion of the first surface of the vibration member and the first vibration apparatus, and a second cover member configured on a portion of the second surface of the vibration member and the second vibration apparatus.

According to one or more embodiments of the present disclosure, the vibration generating module may further comprise a signal supply member electrically connected to the pad portion on the first surface of the vibration member, and a cover member on the first vibration apparatus, the pad portion, and a portion of the signal supply member and configured on the first surface of the vibration member.

According to one or more embodiments of the present disclosure, the vibration generating module may further comprise a signal supply member electrically connected to the pad portion on the first surface of the vibration member, a first cover member on the first vibration apparatus, the pad portion and a portion of the signal supply member and configured on the first surface of the vibration member, and a second cover member configured on the second surface of the vibration member to cover the second vibration apparatus, the pad portion and a portion of the signal supply member.

According to one or more embodiments of the present disclosure, the signal supply member may include a first signal line and a second signal line, which are accommodated between the vibration member and the first cover member.

According to one or more embodiments of the present disclosure, the first signal line may be electrically connected to a second electrode portion of the first vibration apparatus and a first electrode portion of the second vibration apparatus, and the second signal line may be electrically connected to the first electrode portion of the first vibration apparatus and the second electrode portion of the second vibration apparatus.

According to one or more embodiments of the present disclosure, the vibration member may include a metal material or one or more of wood, rubber, plastic, carbon, glass, fiber, cloth, paper, mirror and leather.

According to one or more embodiments of the present disclosure, the vibration generating module may further comprise a first adhesive member connecting the vibration member with the first vibration apparatus, and a second adhesive member connecting the vibration member with the second vibration apparatus.

According to one or more embodiments of the present disclosure, the vibration portion may include a plurality of inorganic material portions including the piezoelectric material, and an organic material portion between the plurality of inorganic material portions.

According to one or more embodiments of the present disclosure, the vibration portion of each of the first vibration apparatus and the second vibration apparatus may include a hole passing through the vibration portion, and the auxiliary electrode portion of each of the first vibration apparatus and the second vibration apparatus may be electrically connected to the second electrode portion by a connection portion filled in the hole.

According to one or more embodiments of the present disclosure, each of the first vibration apparatus and the second vibration apparatus may include: a vibration portion containing a piezoelectric material; a first electrode portion on a first surface of the vibration portion; and a second electrode portion on a second surface opposite to the first surface of the vibration portion.

The vibration portion of each of the first vibration apparatus and the second vibration apparatus may include a hole passing through the vibration portion, and the first connection member and the second connection member may be electrically connected to the second electrode portion by a welding material filled in the hole.

According to one or more embodiments of the present disclosure, the vibration generating module may further comprise: a signal supply member electrically connected to the pad portion on the first surface of the vibration member; a first cover member coupled to a surface of the first vibration apparatus; and a second cover member coupled to a surface of the second vibration apparatus. An end portion of the signal supply member may be disposed between one edge portion of the first cover member and one edge portion of the second cover member.

According to one or more embodiments of the present disclosure, the first conductive member of the first connection member, the auxiliary electrode portion of the first vibration apparatus, and the second electrode portion of the first vibration apparatus may be sequentially connected, and the first conductive member of the first connection member, the first connection portion, the first conductive member of the second connection member, and the first electrode portion of the second vibration apparatus may be sequentially connected.

According to one or more embodiments of the present disclosure, the second conductive member of the first connection member, and the first electrode portion of the first vibration apparatus may be sequentially connected, and the second conductive member of the first connection member, the second connection portion, the second conductive member of the second connection member, the auxiliary electrode portion of the second vibration apparatus, and the second electrode portion of the second vibration apparatus may be sequentially connected.

According to one or more embodiments of the present disclosure, the same signal may be applied to the first electrode portion of the first vibration apparatus and the second electrode portion of the second vibration apparatus, and the same signal may be applied to the second electrode portion of the first vibration apparatus and the first electrode portion of the second vibration apparatus.

A sound apparatus according to one or more embodiments of the present disclosure may comprise an enclosure having an inner space, and a vibration generating module in the inner space. The vibration generating module may be the vibration generating module described above. The vibration generating module according to one or more embodiments of the present disclosure may comprise a vibration member, a pad portion on a first surface of the vibration member, a first vibration apparatus on the first surface of the vibration member and connected to the pad portion, and a second vibration apparatus on a second surface opposite to the first surface of the vibration member and connected to the pad portion.

According to one or more embodiments of the present disclosure, a first vibration apparatus and a second vibration apparatus of the vibration generating module may be in spaces different from each other in the inner space of the enclosure.

According to one or more embodiments of the present disclosure, the enclosure may be connected to the inner space, and further includes an opening portion that overlaps the vibration generating module.

According to one or more embodiments of the present disclosure, the enclosure may include a first enclosure having the opening portion, and a second enclosure connected to the first enclosure, and the vibration generating module may be configured between the first enclosure and the second enclosure.

According to one or more embodiments of the present disclosure, the inner space may include a first space between the first surface of the vibration generating module and the first enclosure and connected to the opening portion, and a second space between a second surface opposite to the first surface of the vibration generating module and the second enclosure.

According to one or more embodiments of the present disclosure, the vibration generating module may include a vibration member disposed in the inner space and supported by the first enclosure and the second enclosure, a pad portion on the first surface of the vibration member, a first vibration apparatus on the first surface of the vibration member and connected to the pad portion, and a second vibration apparatus on a second surface opposite to the first surface of the vibration member and connected to the pad portion.

According to one or more embodiments of the present disclosure, the opening portion may be smaller than the size of the first vibration apparatus.

A vehicular apparatus according to one or more embodiments of the present disclosure may comprise an interior material exposed to an indoor space, and at least one sound generating apparatus outputting sound to the indoor space. The at least one sound generating apparatus may include the sound apparatus described above. The sound apparatus according to one or more embodiments of the present disclosure may comprise an enclosure having an inner space, and a vibration generating module in the inner space. The vibration generating module may include the vibration generating module described above. The vibration generating module according to one or more embodiments of the present disclosure may comprise a vibration member, a pad portion on a first surface of the vibration member, a first vibration apparatus on the first surface of the vibration member and connected to the pad portion, and a second vibration apparatus on a second surface opposite to the first surface of the vibration member and connected to the pad portion.

According to one or more embodiments of the present disclosure, the interior material may include one or more of metal, wood, rubber, plastic, carbon, glass, fiber, cloth, paper, mirror, and leather.

According to one or more embodiments of the present disclosure, the interior material may include at least one of a dash board, a pillar interior material, a roof interior material, a door interior material, a seat interior material, a handle interior material, a floor interior material, a rear package interior material, an overhead console, a rear view mirror, a glove box, a garnish member, and a sun visor, and the at least one sound generating apparatus generates sound by vibrating at least one of the dash board, the pillar interior material, the roof interior material, the door interior material, the seat interior material, the handle interior material, the floor interior material, the rear package interior material, the overhead console, the rear view mirror, the glove box, the garnish member, and the sun visor.

According to one or more embodiments of the present disclosure, the vehicular apparatus may further comprise a main structure and an exterior material covering the main structure. The interior material may be configured to cover at least one of the main structure and the exterior material in the indoor space.

According to one or more embodiments of the present disclosure, the sound apparatus may be placed in one or more of an area between the main structure and the exterior material, an area between the main structure and the interior material, the exterior material, and the interior material, and outputs sound by indirectly or directly vibrating one or more of the main structure, the exterior material, and the interior material.

A vibration generating module according to one or more embodiments of the present disclosure can be applied to or included in a sound apparatus disposed in a vehicular apparatus. The vibration generating module according to one or more example embodiments of the present disclosure can be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. In addition, the vibration generating module according to some example embodiments of the present disclosure can be applied to or included in organic light-emitting lighting apparatuses or inorganic light-emitting lighting apparatuses. When the vibration generating module according to one or more example embodiments of the present disclosure is applied to or included in lighting apparatuses, the lighting apparatuses can act as a lighting device and a speaker.

It will be apparent to those skilled in the art that the present disclosure described above is not limited by the above-described embodiments and the accompanying drawings and that various substitutions, modifications and variations may be made in the present disclosure without departing from the spirit or scope of the disclosures. Consequently, the scope of the present disclosure is intended to cover all variations or modifications derived from the meaning, scope and equivalent concept provided in the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vibration generating structure comprising:
a vibration member including a first surface and a second surface opposite to the first surface;
a pad portion on the first surface of the vibration member;
a first vibration apparatus on the first surface of the vibration member and coupled to the pad portion; and
a second vibration apparatus on the second surface of the vibration member and coupled to the pad portion.

2. The vibration generating structure of claim 1, further comprising:
a signal supply member electrically connected to the pad portion on the first surface of the vibration member.

3. The vibration generating structure of claim 1, further comprising:
a first connection member electrically connected to the pad portion and the first vibration apparatus; and
a second connection member electrically connected to the pad portion and the second vibration apparatus,
wherein the pad portion includes a connection portion electrically connected to the first connection member and the second connection member.

4. The vibration generating structure of claim 3, wherein the connection portion is configured to pass through the first surface and the second surface of the vibration member.

5. The vibration generating structure of claim 3, wherein the connection portion includes:
a hole passing through the first surface and the second surface of the vibration member; and
a conductive material present in the hole.

6. The vibration generating structure of claim 1, wherein each of the first vibration apparatus and the second vibration apparatus includes:
a vibration portion including a piezoelectric material, the vibration portion including a first surface and a second surface opposite to the first surface;
a first electrode portion on the first surface of the vibration portion;
a second electrode portion on the second surface of the vibration portion; and
an auxiliary electrode portion on the first surface of the vibration portion, the auxiliary electrode portion being electrically separated from the first electrode portion and electrically connected to the second electrode portion.

7. The vibration generating structure of claim 6, wherein the auxiliary electrode portion of the first vibration apparatus either overlaps or does not overlap the auxiliary electrode portion of the second vibration apparatus with the vibration member interposed therebetween.

8. The vibration generating structure of claim 7, further comprising:
a first connection member electrically connected to each of the auxiliary electrode portion and the first electrode portion of the first vibration apparatus and the pad portion; and
a second connection member electrically connected to each of the auxiliary electrode portion and the first electrode portion of the second vibration apparatus and the pad portion.

9. The vibration generating structure of claim 8, wherein the pad portion further includes a connection portion electrically connected to the first connection member and the second connection member.

10. The vibration generating structure of claim 9, wherein the connection portion includes a first connection portion and a second connection portion, which are configured to pass through the first and second surfaces of the vibration member and parallel with each other,
wherein any one of the first connection member and the second connection member is electrically connected to the first connection portion, and
wherein the other one of the first connection member and the second connection member is electrically connected to the second connection portion.

11. The vibration generating structure of claim 10, wherein the first connection portion includes:
a first hole passing through the first surface and the second surface of the vibration member; and
a conductive material present in the first hole, and
wherein the second connection portion includes:
a second hole passing through the first surface and the second surface of the vibration member and parallel with the first hole; and
a conductive material present in the second hole.

12. The vibration generating structure of claim 9, wherein the connection portion includes a first connection portion and a second connection portion, which are configured to pass through the first surface and the second surface of the vibration member and parallel with each other,
wherein the first connecting member includes:
a first conductive member electrically connected to the auxiliary electrode portion of the first vibration apparatus and the first connection portion; and
a second conductive member electrically connected to the first electrode portion of the first vibration apparatus and the second connection portion, and
wherein the second connecting member includes:
a first conductive member electrically connected to the first electrode portion of the second vibration apparatus and the first connection portion; and
a second conductive member electrically connected to the auxiliary electrode portion of the second vibration apparatus and the second connection portion.

13. The vibration generating structure of claim 12, wherein the first conductive member and the second conductive member include a conductive tape or lead.

14. The vibration generating structure of claim 2, further comprising:
a first cover member configured on a portion of the first surface of the vibration member and the first vibration apparatus; and
a second cover member configured on a portion of the second surface of the vibration member and the second vibration apparatus.

15. The vibration generating structure of claim 1, further comprising:
a signal supply member electrically connected to the pad portion on the first surface of the vibration member; and
a cover member on the first vibration apparatus, the pad portion, and a portion of the signal supply member and configured on the first surface of the vibration member.

16. The vibration generating structure of claim 1, further comprising:
a signal supply member electrically connected to the pad portion on the first surface of the vibration member;
a first cover member on the first vibration apparatus, the pad portion and a portion of the signal supply member and configured on the first surface of the vibration member; and
a second cover member configured on the second surface of the vibration member to cover the second vibration apparatus, the pad portion and a portion of the signal supply member.

17. The vibration generating structure of claim 14, wherein the signal supply member includes a first signal line and a second signal line, which are accommodated between the vibration member and the first cover member.

18. The vibration generating structure of claim 17, wherein the first signal line is electrically connected to a second electrode portion of the first vibration apparatus and a first electrode portion of the second vibration apparatus, and
wherein the second signal line is electrically connected to the first electrode portion of the first vibration apparatus and the second electrode portion of the second vibration apparatus.

19. A sound apparatus comprising:
an enclosure having an inner space; and
a vibration generating structure in the inner space,
wherein the vibration generating structure includes:
a vibration member including a first surface and a second surface opposite to the first surface;
a pad portion on the first surface of the vibration member;
a first vibration apparatus on the first surface of the vibration member and coupled to the pad portion; and
a second vibration apparatus on the second surface of the vibration member and coupled to the pad portion.

20. A vehicular apparatus comprising:
an interior material exposed to an indoor space; and
at least one sound generating apparatus configured to output sound to the indoor space,
wherein the at least one sound generating apparatus includes a sound apparatus,
wherein the sound apparatus includes:
an enclosure including an inner space; and
a vibration generating structure in the inner space,
wherein the vibration generating structure includes:
a vibration member including a first surface and a second surface opposite to the first surface;
a pad portion on the first surface of the vibration member;
a first vibration apparatus on the first surface of the vibration member and coupled to the pad portion; and
a second vibration apparatus on the second surface of the vibration member and coupled to the pad portion.
